(19) United States
(12) Patent Application Publication
(10) Pub. No.: US 2022/0259487 A1
(43) Pub. Date: Aug. 18, 2022

(54) COMPOSITIONS AND METHODS USING CHLORATE TO BREAK POLYACRYLAMIDE

(71) Applicant: Sabre Intellectual Property Holding LLC, Slingerlands, NY (US)

(72) Inventors: John Y. Mason, Slingerlands, NY (US); Madeline C. Bette, Loudonville, NY (US)

(21) Appl. No.: 17/610,365

(22) PCT Filed: May 8, 2020
(86) PCT No.: PCT/US2020/032081

§ 371 Date: Nov. 10, 2021

Related U.S. Application Data
(60) Provisional application No. 62/978,574, filed on Feb. 19, 2020.
(60) Provisional application No. 62/846,236, filed on May 10, 2019.

(51) Int. Cl. C09K 8/88; C09K 8/92; C09K 8/80; C09K 8/68; C09K 8/70; E21B 43/267

(52) U.S. Cl. CPC C09K 8/882; C09K 8/92; C09K 8/80; C09K 2208/26; C09K 8/706; E21B 43/267; C09K 2208/28; C09K 8/68

(57) ABSTRACT

Provided herein are methods of using chlorate compositions to decrease the viscosity of polyacrylamide containing fluids, such as, for instance, petroleum well treatment fluids (e.g., fracturing fluids). Also provided herein are methods of treating polymer plugging in hydrocarbon bearing subterranean formations using chlorate compositions. Also provided herein are well treatment fluids comprising polyacrylamide and chlorate.

### RELATED APPLICATIONS

This application claims priority to U.S. Provisional Application No. 62/978,574 filed on Feb. 19, 2020 and U.S. Provisional Application No. 62/846,236 filed on May 10, 2019. The content of the foregoing applications is incorporated herein by reference.

### BACKGROUND

Polyacrylamide-containing polymer compositions are used in the petroleum industry and in other industrial applications. Polyacrylamide is also used as a flocculant in water treatment and sludge dewatering and as a soil conditioning agent in agricultural and land management applications. In the petroleum industry, polyacrylamide is used as a viscosity enhancer (e.g., in enhanced oil recovery applications) and as a friction reducer (e.g., in hydraulic fracturing applications).

When polymers are used in petroleum industry applications, a chemical “breaker” may be applied in conjunction with a polymer to break or degrade the polymer after it has been introduced into a hydrocarbon bearing formation, which allows polymer to be removed or partially removed from the formation. Leaving the polymer in the formation can cause problems such as fouling or plugging. Breakers often require elevated temperatures to perform their breaking function. The present disclosure relates to uses of chlorate for breaking polyacrylamide, without the need for elevated temperatures.

It can also be desirable to degrade polymers present in contaminated wastewater. Polyacrylamide contaminated wastewater may result, e.g., from oil and gas operations, agricultural runoff, or accidental spills or leakage. Accordingly, methods provided herein can also be used in wastewater treatment applications.

### SUMMARY

Provided herein are compositions and methods supported by Applicant's discoveries indicating that chlorate is useful for degrading polyacrylamide, particularly anionic polyacrylamide.

In one aspect provided herein is a method comprising introducing a chlorate composition and a well treatment fluid comprising polyacrylamide (e.g., anionic polyacrylamide) into a hydrocarbon bearing subterranean formation such that polyacrylamide (e.g., anionic polyacrylamide) from the well treatment fluid is exposed to chlorate from the chlorate composition.

In another aspect provided herein is a method comprising administering a chlorate composition to a polyacrylamide-containing fluid (e.g., a polyacrylamide containing base fluid as disclosed herein) to form a combined composition, such that the polyacrylamide is exposed to (or contacts) chlorate from the chlorate composition, thereby decreasing the viscosity of the combined composition relative to the initial viscosity.

In another aspect provided herein is a method of treating a hydrocarbon bearing subterranean formation, the method comprising introducing a well treatment fluid into a hydrocarbon bearing subterranean formation, the well treatment fluid comprising polyacrylamide (e.g., anionic polyacrylamide) and a chlorate salt (e.g., sodium chlorate) that provides a relative concentration of 3% to 40% (w/w) chlorate (anion) to polyacrylamide (e.g., anionic polyacrylamide), wherein the well treatment fluid has a pH of 5 to 8.

In another aspect provided herein is a method of making a well treatment fluid, the method comprising (i) mixing well treatment components to form a well treatment fluid, the well treatment components including (a) an aqueous base fluid, (b) a friction reducer comprising polyacrylamide (e.g., anionic polyacrylamide), and (c) a chlorate composition that provides a relative concentration of 3% to 40% (w/w) chlorate anion to polyacrylamide (e.g., anionic polyacrylamide) in the well treatment fluid, wherein the well treatment fluid has a pH of 5 to 8, and (ii) introducing the well treatment fluid into a wellbore penetrating a hydrocarbon bearing subterranean formation.

Also provided herein are well treatment fluids.

In one aspect provided herein is a well treatment fluid comprising anionic polyacrylamide, and a chlorate salt in an amount that provides a relative concentration of 3% to 40% (w/w) chlorate (anion) to polyacrylamide, the well treatment fluid having a pH of 5 to 8.

The methods and well treatment fluids can include other steps or features disclosed herein.

### BRIEF DESCRIPTION OF THE DRAWINGS

FIG. 1 shows viscosity reducing effects of persulfate and of a chlorate composition on a solvated polyacrylamide composition at ambient temperature. The top graph shows the average viscosity for each dose. Error bars represent one standard deviation from the mean. The bottom graph shows the average viscosity reduction for each dose.

FIG. 2 shows the results of viscosity measurements taken over time after introducing a chlorate composition (top graph) or persulfate (bottom graph) to a solvated polyacrylamide composition at ambient temperature.

FIG. 3 shows the results of viscosity measurements taken over time after introducing persulfate or a chlorate composition to a solvated polyacrylamide composition at ambient temperature (top graph) or at 180° F. (bottom graph).

FIG. 4 shows the results of viscosity measurements taken over time after introducing a chlorate composition to a polyacrylamide composition solvated in a 1% synthetic brine at ambient temperature (top graph) or at 150° F. (bottom graph).

FIG. 5 shows the results of viscosity measurements taken over time after introducing a chlorate composition to a solvated guar composition at ambient temperature (top graph) or at 150° F. (bottom graph).

FIG. 6 shows results of viscosity measurements taken over time after introducing various breaker compositions to a solvated polyacrylamide composition at ambient temperature (top graph) or at 150° F. (bottom graph).

FIG. 7 shows viscosity reducing effects of persulfate and of a chlorate composition on a solvated polyacrylamide composition at ambient temperature. The top graph shows the average viscosity for each dose. Error bars represent one standard deviation from the mean. The bottom graph shows the average viscosity reduction for each dose.

FIG. 8 shows the results of viscosity measurements taken over time after introducing a chlorate composition (top graph) or persulfate (bottom graph) to a solvated polyacrylamide composition at ambient temperature.

FIG. 9 shows the viscosity measurements taken over time in the chlorate treated, persulfate treated and control samples of PA compositions #1 (top) and #2 (bottom).

FIG. 10 shows the viscosity measurements taken over time in the chlorate treated, persulfate treated and control samples of PA compositions #3 (top) and #4 (bottom).

FIG. 11 shows the viscosity measurements taken over time in the chlorate treated, persulfate treated and control samples of PA compositions #5 (top) and #6 (bottom).

FIG. 12 shows the viscosity measurements taken over time in the chlorate treated, persulfate treated and control samples of PA compositions #7 (top) and #8 (bottom).

FIG. 13 shows MWCO results for chlorate treated, persulfate treated and control samples of PA composition #3. The top graph shows size distribution results and the bottom graph shows changes in size relative to control.

FIG. 14 shows MWCO results for chlorate treated, persulfate treated and control samples of PA composition #8. The top graph shows size distribution results and the bottom graph shows changes in size relative to control.

### DETAILED DESCRIPTION

### Definitions

As used herein, an “aqueous” base fluid refers to a base fluid that is predominantly made up of water (i.e., more than 50% water). In some embodiments, the aqueous base fluid comprises at least 55%, 60%, 65%, 70%, 75%, 80%, 85%, 90% or 95% water). In some embodiments, the aqueous base fluid comprises or consists of produced water. In some embodiments, the aqueous base fluid comprises up to 1%, 2%, 3%, 4%, 5%, 6%, 7%, 8%, 9%, or 10% of a salt.

As used herein, the term “comprising” generally includes “consisting essentially of” and “consisting of”. Accordingly, a composition or method that comprises certain elements can also consist essentially of, or consist of, those elements.

As used herein, a “conventional breaker” means a breaker, other than chlorate, that is effective for reducing the viscosity of the well treatment fluid (or other fluid including polyacrylamide being treated) at a temperature of 74° F. In some embodiments, the conventional breaker (or other breaker) is an oxidizing breaker.

Conventional breakers other than chlorate are known in the art. Other breakers can include, for example, persulfates (e.g., sodium persulfate, potassium persulfate, and ammonium persulfate), hypochlorites (e.g., lithium and/or sodium hypochlorites), chlorites (e.g., sodium chlorite), peroxides (e.g., hydrogen peroxide, magnesium peroxide, calcium peroxide, and urea-hydrogen peroxide), perborates (e.g., sodium perborate), percarbonates, (which release peroxide and include, e.g., sodium percarbonate, calcium percarbonate), bromates, periodates, and permanganates.

As used herein, a “fluid” refers to a pumpable medium.

As used herein, a “friction reducer” refers to a composition containing a polymer suitable for reducing friction. In some embodiments, the friction reducer contains other components, e.g., an organic solvent (e.g., at a concentration of up to 20%) and/or surfactant (e.g., at a concentration of up to 10%).

As used herein, the “percent,” “percentage” or “%” of a component refers to the w/w%, unless the context indicates otherwise.

As used herein, “ppm” refers to parts per million by weight.

As used herein “viscosity” generally refers to dynamic or absolute viscosity. Viscosity can be determined using a Brookfield spindle viscometer (or equivalent viscosity measurement device) at 60 RPM, at atmospheric pressure, and at temperature of 74° F.

As used herein, a “well treatment fluid” is a pumpable medium for application to a well that is used in petroleum (e.g., oil and/or gas) mining operations. A well treatment fluid can be, e.g., a hydraulic fracturing fluid, a polymer flooding fluid, or a stimulation fluid (e.g., for remediation or enhanced oil recovery).

Applicant has discovered that chlorate is specifically useful for breaking polyacrylamide, as indicated by the ability of chlorate to decrease the viscosity of polyacrylamide containing fluids and to reduce the size of polyacrylamide polymers. Persulfate is a conventional breaker that is typically used to break down guar, polyacrylamides and other polymers used in oilfield operations such as hydraulic fracturing. Applicant has discovered that chlorate can be used as an alternative breaker specifically for breaking polyacrylamide and can be more effective than other breakers, such as, e.g., persulfate. Exemplary effects of chlorate breaker compositions are described herein in the Examples. Because chlorate is relatively inexpensive and nontoxic, chlorate can serve as a commercially viable alternative breaker.

Using chlorate as a breaker has advantages over persulfate because undesirable reactions can occur in the context of persulfate application. Persulfate degrades into oxygen and sulfate groups. The oxygen can feed bacteria and cause growth of biofilm and biomass. This can result in microbial damage. In oil industry applications (such as fracturing, polymer flooding, and stimulation or enhanced oil recovery operations), microbial damage can result in corrosion and/or plugging. Sulfates can also react with barium and strontium that occur naturally in hydrocarbon bearing formations, resulting in formation of insoluble scale that plugs the formation.

### Methods

Methods disclosed herein are useful in industry, for instance, for treating hydrocarbon bearing subterranean formations, for treating water contaminated with polyacrylamide, and/or for making well treatment fluids.

The methods can include combinations of steps and/or features disclosed herein. In some embodiments, the methods do not comprise steps and/or features that are not exemplified herein. In some embodiments, the methods do not comprise steps and/or features that are not disclosed herein.

In one aspect provided herein is a method comprising administering a chlorate composition to a polyacrylamide-containing fluid (e.g., a polyacrylamide containing base fluid as disclosed herein) to form a combined composition (e.g., a well treatment fluid), such that the polyacrylamide is exposed to (or contacts) chlorate from the chlorate composition, thereby decreasing the viscosity of the combined composition relative to the initial viscosity.

In some embodiments, the combined composition initially comprises at least 10 ppm, 20 ppm, 30 ppm, 40 ppm, or 50 ppm polyacrylamide (e.g., anionic polyacrylamide). In some embodiments, combined composition initially comprises up to 500 ppm, 800 ppm 1000 ppm, 5000 ppm, or 10,000 ppm polyacrylamide (e.g., anionic polyacrylamide). In some embodiments, the combined composition comprises at least 40 ppm (e.g., 40 to 1000 ppm, 50 to 800 ppm or 50 to 600 ppm) polyacrylamide (e.g., anionic polyacrylamide).

In some embodiments, the combined composition has a pH of 5 to 8 or of 6 to 8.

Generally, the combined composition does not cause significant corrosion of metals (e.g., metals from which oilfield equipment is made), as indicated by a corrosion speed of less than 5 mg/(m²*h). In some embodiments, the combined composition has a corrosion speed of less than 2 mg/(m²*h) or less than 1 mg/(m²*h).

In some embodiments, the combined composition does not include a corrosion inhibitor.

In some embodiments, the polyacrylamide is anionic polyacrylamide. In some embodiments, the polyacrylamide-containing fluid and/or the combined composition comprises at least 70%, 75%, 80%, 85%, 90%, or 95% polyacrylamide (e.g., anionic polyacrylamide) relative to other polymers, if any. In some embodiments, the combined composition comprises less than 10% guar or guar derivatives, relative to other polymers. In some embodiments, the combined composition comprises less than 5% guar or guar derivatives, relative to other polymers.

The methods disclosed herein can include other steps or features disclosed herein.

In another aspect provided herein is a method of degrading polyacrylamide in a well treatment operation, the method comprising introducing (e.g., pumping) a chlorate composition and a polyacrylamide (e.g., anionic polyacrylamide) composition (e.g., a friction reducer containing polyacrylamide (e.g., anionic polyacrylamide)) into a hydrocarbon bearing subterranean formation. In some embodiments, the chlorate composition is administered so as to provide a relative concentration of chlorate (anion) to polyacrylamide as disclosed herein (e.g., a relative concentration of 3% to 40% (w/w)). In some embodiments, the method comprises combining the chlorate composition and the polyacrylamide composition to form a combined well treatment fluid before introducing the combined well treatment fluid into the hydrocarbon bearing subterranean formation. In some embodiments, the combined well treatment fluid has a pH greater than 4. In some embodiments, the combined well treatment fluid has a pH of 4 to 8. In some embodiments, the combined well treatment fluid has a pH of 5 to 8. In some embodiments, the combined well treatment fluid has a pH of 6 to 8. In some embodiments, the combined well treatment fluid initially comprises at least 10 ppm, 20 ppm, 30 ppm, 40 ppm, or 50 ppm polyacrylamide (e.g., anionic polyacrylamide). In some embodiments, the combined well treatment fluid initially comprises up to 500 ppm, 800 ppm 1000 ppm, 5000 ppm, or 10,000 ppm polyacrylamide (e.g., anionic polyacrylamide). In some embodiments, the combined well treatment fluid initially comprises at least 40 ppm (e.g., 40 to 1000 ppm, 50 to 800 ppm or 50 to 600 ppm) polyacrylamide (e.g., anionic polyacrylamide). In some embodiments, the combined well treatment fluid contains a proportion of at least 60%, 70%, 75%, 80%, 85%, 90%, 95%, 96%, 97%, 98%, or 99% by weight polyacrylamide relative to other polymers, if any. In some embodiments, the combined well treatment fluid contains a proportion of less than 10% (e.g., less than 5%) by weight of guar or guar derivatives relative to other polymers, if any. In some embodiments, the combined well treatment fluid contains a proportion of less than 10% (e.g., less than 5% by weight) of guar and guar derivatives relative to other polymers, if any. In some embodiments, the combined well treatment fluid contains at least 80%, 85%, 90% 95%, 96%, 97%, 98%, or 99% by weight chlorate anions relative to total weight of other breaker anions. In some embodiments, the well treatment fluid contains at least 80%, 85%, 90%, 95%, 96%, 97%, 98%, or 99% by weight chlorate anions relative to total weight of persulfate anions, chlorite anions, peroxide anions, and perborate anions, if any. In some embodiments, the combined well treatment fluid is a fracturing fluid. In some embodiments, the combined well treatment fluid (e.g., the fracturing fluid) is introduced into the hydrocarbon bearing subterranean formation within 20 minutes of the mixing. In some embodiments, the combined well treatment fluid (e.g., the fracturing fluid) is introduced into the hydrocarbon bearing subterranean formation within 15 minutes (e.g., within 10 min., 5 min., 3 min, or 2 min.) of the mixing.

In some embodiments, the well treatment operation is an initial completion.

In some embodiments, the introducing comprises introducing the chlorate composition and the polyacrylamide composition into a wellbore of a well that penetrates the hydrocarbon bearing subterranean formation.

In some embodiments, the method further comprises retrieving flowback fluid from the well. Typically, the flowback fluid comprises broken polyacrylamide.

In some embodiments, the retrieving is performed within 24 hours of the introducing.

In some embodiments, the retrieving is performed more than 12 hours (e.g., more than 1 day, 2 days, 3 days, 5 days, 1 week, 10 days, 2 weeks, 3 weeks or 4 weeks) following the introducing.

In some embodiments, the method further comprises shutting in the well. In some embodiments, the method comprises shutting in the well for at least 12 hours, 1 day, 2 days, 3 days, 5 days, 1 week, 10 days, 2 weeks, 3 weeks or 4 weeks following the introducing. In some embodiments, the method further comprises retrieving flowback fluid from the well following the shutting in.

In some embodiments, the retrieving is performed between 2 days and 8 weeks (e.g., between 2 days and 8 weeks or 3 days and 8 weeks) following the introducing. In another aspect provided herein is a method of decreasing viscosity of a well treatment fluid, the method comprising introducing (e.g., pumping) a chlorate composition and a well treatment fluid comprising polyacrylamide into a hydrocarbon bearing subterranean formation such that polyacrylamide from the well treatment fluid is exposed to chlorate from the chlorate composition.

In some embodiments, the polyacrylamide is anionic polyacrylamide.

In some embodiments, the introducing is performed for the purpose of an initial completion (e.g., hydraulic fracturing) operation, a polymer flooding operation, or a stimulation operation.

In some embodiments, the introducing is performed for the purpose of an initial completion.

In some embodiments, the introducing comprises introducing the chlorate composition and the polyacrylamide composition into a wellbore of a well that penetrates the hydrocarbon bearing subterranean formation.

In some embodiments, the method further comprises retrieving flowback fluid from the well. In some embodiments, the retrieving is performed more than 12 hours (e.g., more than 1 day, more than 2 days, more than 3 days, more than 5 days, more than 1 week, more than 10 days, more than 2 weeks, more than 3 weeks or more than 4 weeks following the introducing).

In some embodiments, the method further comprises shutting in the well. In some embodiments, the method comprises shutting in the well for at least 12 hours, 1 day, 2 days, 3 days, 5 days, 1 week, 10 days, 2 weeks, 3 weeks or 4 weeks following the introducing. In some embodiments, the method further comprises retrieving flowback fluid from the well following the shutting in. In some embodiments, the retrieving is performed between 2 days and 8 weeks (e.g., between 2 days and 8 weeks or 3 days and 8 weeks) following the introducing.

Generally, the flowback fluid comprises broken polyacrylamide.

In some embodiments, the method comprises introducing a friction reducer containing the polyacrylamide into a base fluid (e.g., a base fluid disclosed herein) to form the well treatment fluid.

In some embodiments, the friction reducer contains polyacrylamide at a concentration of at least 10%, at least 15% or at least 20%. In some embodiments, the friction reducer contains polyacrylamide at a concentration of 10% to 90%, 20% to 90%, 20% to 40% or 25% to 35%.

In some embodiments, the friction reducer is introduced in an amount of 0.25 to 1 gallon per thousand gallons of base fluid. In some embodiments, the friction reducer is introduced so as to provide a concentration of polyacrylamide (e.g., anionic polyacrylamide) disclosed herein.

In some embodiments, the well treatment fluid initially comprises at least 10 ppm, 20 ppm, 30 ppm, 40 ppm, or 50 ppm polyacrylamide (e.g., anionic polyacrylamide). In some embodiments, the well treatment fluid initially comprises up to 500 ppm, 800 ppm 1000 ppm, 5000 ppm, or 10,000 ppm polyacrylamide (e.g., anionic polyacrylamide).

In some embodiments, the method comprises pumping the chlorate composition and the well treatment fluid into a wellbore or portion thereof that penetrates the hydrocarbon bearing subterranean formation. In some embodiments, the method comprises pumping a combination (e.g., a mixture) of the well treatment fluid and the chlorate composition into a wellbore or portion thereof that penetrates the hydrocarbon bearing subterranean formation. In some embodiments, the combination is a fluid having a pH greater than 4, e.g., a pH of 5 to 8 or a pH of 6 to 8.

Generally, the chlorate composition and the well treatment fluid (e.g., the combination, e.g., the mixture thereof) do not cause significant corrosion of metals (e.g., metals used to make oilfield equipment), as indicated by a corrosion speed of less than 5 mg/(m²*h), e.g., less than 2 mg/(m²*h) or less than 1 mg/(m²*h).

In some embodiments, the method does not comprise introducing (e.g., pumping) a corrosion inhibitor into the wellbore.

In some embodiments, the combination comprises at least 40 ppm (e.g., 40 to 1000 ppm, 50 to 800 ppm or 50 to 600 ppm) polyacrylamide (e.g., anionic polyacrylamide). In some embodiments, the combination comprises a proppant, e.g., sand.

In some embodiments, the well treatment fluid initially comprises at least 40 ppm (e.g., 40 to 1000 ppm, 50 to 800 ppm or 50 to 600 ppm) polyacrylamide (e.g., anionic polyacrylamide). In some embodiments, the well treatment fluid comprises a proppant, e.g., sand.

In some embodiments, the pumping is performed so as to fracture the hydrocarbon bearing subterranean formation. In some embodiments, the pumping is at a flow rate and pressure sufficient to fracture the hydrocarbon bearing subterranean formation.

In some embodiments, the wellbore or portion thereof has a temperature of less than 120° F. In some embodiments, the wellbore or portion thereof has a temperature of less than 110° F. In some embodiments, the wellbore or portion thereof has a temperature of 105° F. or less. In some embodiments, the wellbore or portion thereof has a temperature of 100° F. or less.

Certain methods or method steps disclosed herein are particularly suitable for application at relatively low temperatures, as disclosed herein. Accordingly, in some embodiments, a method disclosed herein comprises selecting a hydrocarbon bearing subterranean formation, or a wellbore or portion thereof, having a temperature disclosed herein (e.g., a temperature of less than 120° F., less than 110° F., 105° F. or less, or 100° F. or less) for application of the method or method steps.

In some embodiments, the method comprises selecting a wellbore or portion thereof that has a temperature of less than 120° F. In some embodiments, the method comprises selecting a wellbore or portion thereof that has a temperature of less than 110° F. In some embodiments, the method comprises selecting a wellbore or portion thereof that has a temperature of 105° F. or less. In some embodiments, the method comprises selecting a wellbore or portion thereof that has a temperature of 100 F. or less.

In some embodiments, the wellbore has a bottom hole temperature of less than 120° F. In some embodiments, the wellbore has a bottom hole temperature of less than 110° F. In some embodiments, the wellbore has a bottom hole temperature of 105° F. or less. In some embodiments, the wellbore has a bottom hole temperature of 100° F. or less.

In some embodiments, the method comprises selecting a wellbore that has a bottom hole temperature as disclosed herein (e.g, a bottom hole temperature of less than 120° F., less than 110° F., 105° F. or less, or 100° F. or less).

In some embodiments, the chlorate composition and the well treatment fluid are introduced separately into the hydrocarbon bearing subterranean formation (e.g., into a wellbore or portion thereof that penetrates the hydrocarbon bearing subterranean formation).

In some embodiments, the chlorate composition and the well treatment fluid are introduced into the hydrocarbon bearing subterranean formation (e.g., into a wellbore or portion thereof that penetrates the hydrocarbon bearing subterranean formation) at the same time.

In other embodiments, the chlorate composition and the well treatment fluid comprising polyacrylamide (e.g., the well treatment fluid comprising polyacrylamide at a concentration disclosed herein) are introduced into the hydrocarbon bearing subterranean formation separately. In some such embodiments, the chlorate composition is introduced alternately with the well treatment fluid comprising polyacrylamide. In some such embodiments, the chlorate composition is introduced so as to provide a relative concentration of chlorate anion to polyacrylamide as disclosed herein.

In some embodiments, method comprises introducing a mixture of the chlorate composition and the well treatment fluid into the hydrocarbon bearing subterranean formation (e.g., into a wellbore or portion thereof that penetrates the hydrocarbon bearing subterranean formation).

In some embodiments, the method comprises mixing the chlorate composition and the well treatment fluid to form the mixture. In some embodiments, the mixing is performed before the mixture is introduced into the subterranean formation.

In some embodiments, the method comprises mixing the well treatment fluid with the chlorate composition to form a mixture and introducing the mixture into the hydrocarbon bearing subterranean formation (e.g., into a wellbore or portion thereof that penetrates the hydrocarbon bearing subterranean formation). In some embodiments, the mixture has a pH of greater than 4. In some embodiments, the mixture has a pH greater than 4, e.g., a pH of 5 to 8 or of 6 to 8. In some embodiments, the mixture is introduced into the hydrocarbon bearing subterranean formation within 15 minutes (e.g., within 10 min., 5 min., 3 min, or 2 min.) of the mixing.

Generally, the chlorate composition and the well treatment fluid (e.g., the combination, e.g., the mixture thereof) do not cause significant corrosion of metals (e.g., metals used to make oilfield equipment), as indicated by a corrosion speed of less than 5 mg/(m²*h), e.g., less than 2 mg/(m²*h) or less than 1 mg/(m²*h).

In some embodiments, the method does not comprise introducing (e.g., pumping) a corrosion inhibitor into the wellbore. In some embodiments of these methods, the chlorate composition is introduced so as to provide a relative concentration as disclosed herein of chlorate anion to polyacrylamide (e.g., anionic polyacrylamide).

In some embodiments, the method comprises introducing the chlorate composition in proportion to the well treatment fluid (and thus to the polyacrylamide) so as to provide a chlorate concentration, in combined fluid formed by combination of the well treatment fluid and the chlorate composition, that is sufficient to provide a decreased viscosity in said combined fluid, wherein said decreased viscosity is at least 15% less (e.g., at least 20%, 25%, or 35% less) than the initial viscosity of the well treatment fluid. The concentration of chlorate that is sufficient to provide such decreased viscosity can be determined under laboratory conditions as disclosed herein.

In some embodiments, the method comprises introducing the chlorate composition in proportion to the well treatment fluid (and thus to the polyacrylamide) so as to provide a chlorate concentration, in combined fluid formed by combination of the well treatment fluid and the chlorate composition, that is sufficient to provide a decreased viscosity in said combined fluid, wherein said decreased viscosity is at least 40% less (e.g., at least 45%, 50%, 55%, 60%, 65%, 70%, 75%, 80%, 85%, or 90% less) than the initial viscosity of the well treatment fluid. The concentration of chlorate that is sufficient to provide such decreased viscosity can be determined under laboratory conditions as disclosed herein.

In some embodiments, the initial viscosity of the well treatment fluid is 5 cP to 70 cP or 10 cP to 60 cP.

In some embodiments of these methods, the chlorate composition is introduced in proportion to the well treatment fluid so as to provide chlorate at a concentration of at least 40 mg/l, 50 mg/l, 60 mg/l, 70 mg/l, 80 mg/l, 90 mg/l, or 100 mg/l in combination fluid formed by combination of the well treatment fluid and the chlorate composition. In some embodiments, the chlorate composition is introduced in proportion to the well treatment fluid so as to provide chlorate at a concentration of up to 500 mg/l, 1000 m/gl, 1500 m/gl, 2500 mg/l, 3000 mg/l, 3500 mg/l, 4000 mg/l, 4500 mg/l or 5000 mg/l in the combination fluid. In some embodiments, the chlorate composition is introduced in proportion to polyacrylamide included in the well treatment fluid such that most of the chlorate (i.e., more than 50% of the chlorate, e.g., at least 70%, 80%, 90%, or 95% of the chlorate) from the chlorate composition reacts with the polyacrylamide. In some embodiments of the methods, the polyacrylamide from the well treatment fluid is exposed to chlorate from the chlorate composition at a temperature of less than 120° F. In some embodiments of the methods, the polyacrylamide from the well treatment fluid is exposed to chlorate from the chlorate composition at a temperature of less than 110° F. In some embodiments, the polyacrylamide from the well treatment fluid is exposed to chlorate from the chlorate composition at a temperature of 105° F. or less. In some embodiments, the polyacrylamide from the well treatment fluid is exposed to chlorate from the chlorate composition at a temperature of 100° F. or less.

In some embodiments, the chlorate composition, the well treatment fluid, or both comprise one or more other conventional breakers (in addition to chlorate). In some embodiments, the one or more other breakers is an oxidizing breaker. In some embodiments, the chlorate composition and/or the well treatment fluid comprises a proportion of at least 70%, 75%, 80%, 85%, 90%, 95%, 96%, 97%, 98%, or 99% chlorate anion by weight relative to the total weight of said one or more other breaker anions.

Other breakers can include, e.g., persulfates (which can refer to ions or compounds containing the anions SO₅²⁻ or S₂O₈²⁻), chlorite, peroxides (e.g., hydrogen peroxide), and perborates.

In some embodiments, said one or more other breakers is a persulfate, a chlorite, or a peroxide. In some embodiments, said one or more other breakers is a persulfate, a chlorite, a peroxide, or a perborate.

In some embodiments, the well treatment fluid contains a proportion of at least 60%, 70%, 75%, 80%, 85%, 90%, 95%, 96%, 97%, 98%, or 99% by weight polyacrylamide relative to other polymers, if any.

In some embodiments, the well treatment fluid contains less than 30%, less than 20%, less than 10%, less than 5%, less than 4%, less than 3%, less than 2%, or less than 1% guar or guar derivatives.

In some embodiments, the well treatment fluid comprises produced water. In some embodiments, the well treatment fluid comprises a brine. In some embodiments, the well treatment fluid comprises up to 1%, 2%, 3%, 4%, 5%, 6%, 7%, 8%, 9%, or 10% of a salt.

In another aspect provided herein is a method comprising administering a chlorate composition to a solvated polyacrylamide composition having an initial viscosity to form a combined composition, such that chlorate from the chlorate composition contacts solvated polyacrylamide from the polyacrylamide composition.

In some embodiments, the solvated polyacrylamide composition comprises at least 10 ppm, 20 ppm, 30 ppm, 40 ppm, or 50 ppm polyacrylamide (e.g., anionic polyacrylamide). In some embodiments, the solvated polyacrylamide composition comprises up to 500 ppm, 800 ppm 1000 ppm, 5000 ppm, or 10,000 ppm polyacrylamide (e.g., anionic polyacrylamide). In some embodiments, the solvated polyacrylamide composition comprises at least 40 ppm (e.g., 40 to 1000 ppm, 50 to 800 ppm or 50 to 600 ppm) polyacrylamide (e.g., anionic polyacrylamide).

In some embodiments, the combined composition initially comprises at least 10 ppm, 20 ppm, 30 ppm, 40 ppm, or 50 ppm polyacrylamide (e.g., anionic polyacrylamide). In some embodiments, the combined composition initially comprises up to 500 ppm, 800 ppm 1000 ppm, 5000 ppm, or 10,000 ppm polyacrylamide (e.g., anionic polyacrylamide).

In some embodiments, the combined composition has a concentration of at least 40 ppm (e.g., 40 to 1000 ppm, 50 to 800 ppm or 50 to 600 ppm) polyacrylamide (e.g., anionic polyacrylamide).

In some embodiments, the chlorate composition is administered to provide a concentration of chlorate in the combined composition that is sufficient, at a temperature of 70° F., to reduce the viscosity of the combined composition by at least 40% (e.g., by at least 45%, 50%, 55%, 60%, 65%, 70%, 75%, 80%, 85%, or 90%) compared with the initial viscosity.

In some embodiments, the viscosity reduction persists for at least 1 day, 2 days, 3 days, 5 days, 1 week, 2 weeks, or 1 month.

In some embodiments, the chlorate composition is administered to provide a concentration of at least 40 mg/l, 50 mg/l, 60 mg/l, 70 mg/l, 80 mg/l, 90 mg/l, or 100 mg/l of chlorate in the combined composition. This chlorate concentration refers to the initial concentration calculated based on the amount of chlorate in the chlorate composition and the volume of the combined composition.

Without wishing to be bound by theory, it is expected that chlorate from the chlorate composition will react with polyacrylamide, such that the concentration of chlorate remaining after the reaction will be less. In some embodiments, the chlorate composition reacts with the polyacrylamide, such that the concentration of chlorate remaining in the combined composition after such reaction is less than 20 mg/l, 10 mg/l, 5 mg/l, 3 mg/l, 2 mg/l, 1 mg/l, or 0.5 mg/l. In some embodiments, the chlorate from the chlorate composition reacts with the polyacrylamide, such that the concentration of chlorate remaining after such reaction is 50% or less (e.g., 40%, 30%, 25%, 20%, 15%, 10%, or 5% or less) of the initial chlorate concentration in the combined composition.

In some embodiments, the initial viscosity is 5 cP to 70 cP or 10 cP to 60 cP.

In some embodiments, the combined composition initially comprises at least 10 ppm, 20 ppm, 30 ppm, 40 ppm, or 50 ppm polyacrylamide (e.g., anionic polyacrylamide). In some embodiments, the combined composition initially comprises up to 500 ppm, 800 ppm 1000 ppm, 5000 ppm, or 10,000 ppm polyacrylamide (e.g., anionic polyacrylamide). In some embodiments, the combined composition initially comprises at least 40 ppm (e.g., 40 to 1000 ppm, 50 to 800 ppm or 50 to 600 ppm) polyacrylamide (e.g., anionic polyacrylamide).

In some embodiments, the chlorate contacts solvated polyacrylamide at a temperature of less than 120° F. In some embodiments, the chlorate contacts solvated polyacrylamide at a temperature of less than 110° F. In some embodiments, the chlorate contacts solvated polyacrylamide at a temperature of 105° F. or less. In some embodiments, the chlorate contacts solvated polyacrylamide at a temperature of 100° F. or less.

In some embodiments, the method further comprises introducing the combined composition into a hydrocarbon bearing subterranean formation.

In some embodiments, the method comprises introducing the combined composition into a wellbore or portion thereof that penetrates the hydrocarbon bearing subterranean formation.

The method can comprise other steps or features disclosed herein.

In a further aspect provided herein is a method comprising (i) introducing a polyacrylamide composition into a base fluid (e.g., for a solvation period of at least 2, 5, 7, 8, 9, or 10 minutes) to make a solvated polyacrylamide composition having an initial viscosity, and (ii) administering a chlorate composition to the solvated polyacrylamide composition to form a combined composition, such that chlorate from the chlorate composition contacts solvated polyacrylamide, wherein the chlorate composition is administered to provide a concentration of chlorate in the combined composition that is sufficient to reduce the viscosity of the combined composition by at least 40% (e.g., at least 45%, 50%, 55%, 60%, 65%, 70%, 75%, 80%, 85%, or 90%) compared with the initial viscosity. The concentration of chlorate sufficient to provide such decreased viscosity can be determined under laboratory conditions as disclosed herein. In some embodiments, the viscosity reduction persists for at least 1 day, 2 days, 3 days, 5 days, 1 week, 2 weeks, or 1 month.

In some embodiments, the method comprises mixing the polyacrylamide composition with the base fluid. In some embodiments, the mixing is performed during a solvation period, e.g., of at least 2, 5, 7, 8, 9, or 10 minutes. Such mixing can be performed continuously or intermittently during the solvation period.

In some embodiments, the initial viscosity is 2 cP to 70 cP, 5 cP to 70 cP, or 10 cP to 60 cP.

The base fluid can be an aqueous or non-aqueous fluid. In some embodiments, the base fluid is predominantly water (more than 50% water, e.g., at least 55%, 60%, 65%, 70%, 75%, 80%, 85%, 90% or 95% water). In some such embodiments, the base fluid also contains non-aqueous components.

In some embodiments, the base fluid comprises produced water. In some embodiments, the base fluid comprises a brine. In some embodiments, the base fluid comprises a well treatment fluid. In some embodiments, the base fluid is a well treatment fluid. The well treatment fluid can also contain other components known in the art for use in well treatments. In some embodiments, the base fluid comprises chlorine dioxide, e.g., 0.5 to 20 mg/l, 0.5 to 10 mg/l or 0.5 to 5 mg/l chlorine dioxide.

In some embodiments of these methods, the chlorate composition is introduced (in proportion to the solvated polyacrylamide composition) so as to provide chlorate at a concentration of at least 40 mg/l, 50 mg/l, 60 mg/l, 70 mg/l, 80 mg/l, 90 mg/l, or 100 mg/l the combined composition. In some embodiments, the chlorate composition is introduced so as to provide chlorate at a concentration of up to 500 mg/l, 1000 m/gl, 1500 m/gl, 2500 mg/l, 3000 mg/l, 3500 mg/l, 4000 mg/l, 4500 mg/l or 5000 mg/l in the combined composition.

Without wishing to be bound by theory, it is expected that chlorate from the chlorate composition will react with polyacrylamide, such that the concentration of chlorate remaining in the combined composition after the reaction will be less. In some embodiments, the chlorate composition reacts with the polyacrylamide, such that the concentration of chlorate remaining in the combined composition after such reaction is less than 20 mg/l, 10 mg/l, 5 mg/l, 3 mg/l, 2 mg/l, 1 mg/l, or 0.5 mg/l.

In some embodiments of these methods, the chlorate composition is introduced (in proportion to the solvated polyacrylamide composition) such that most of the chlorate (i.e., more than 50% of the chlorate, e.g., at least 70%, 80%, 90%, or 95% of the chlorate) from the chlorate composition reacts with the polyacrylamide. In some embodiments, the chlorate from the chlorate composition reacts with the polyacrylamide, such that the concentration of chlorate remaining after such reaction is 50% or less (e.g., 40%, 30%, 25%, 20%, 15%, 10%, or 5% or less) of the initial chlorate concentration in the combined composition.

In some embodiments, the solvated polyacrylamide composition comprises at least 10 ppm, 20 ppm, 30 ppm, 40 ppm, or 50 ppm polyacrylamide (e.g., anionic polyacrylamide). In some embodiments, the solvated polyacrylamide composition comprises up to 500 ppm, 800 ppm 1000 ppm, 5000 ppm, or 10,000 ppm polyacrylamide (e.g., anionic polyacrylamide). In some embodiments, the solvated polyacrylamide composition comprises at least 40 ppm (e.g., 40 to 1000 ppm, 50 to 800 ppm or 50 to 600 ppm) polyacrylamide (e.g., anionic polyacrylamide).

In some embodiments, the combined composition initially comprises at least 10 ppm, 20 ppm, 30 ppm, 40 ppm, or 50 ppm polyacrylamide (e.g., anionic polyacrylamide). In some embodiments, the combined composition initially comprises up to 500 ppm, 800 ppm 1000 ppm, 5000 ppm, or 10,000 ppm polyacrylamide (e.g., anionic polyacrylamide). In some embodiments, the combined composition initially comprises at least 40 ppm (e.g., 40 to 1000 ppm, 50 to 800 ppm or 50 to 600 ppm) polyacrylamide (e.g., anionic polyacrylamide).

In another aspect provided herein is a method of treating polymer plugging in a hydrocarbon bearing subterranean formation, the method comprising (i) introducing a treatment fluid comprising a chlorate composition into a hydrocarbon bearing subterranean formation that has previously been treated with polyacrylamide, (ii) allowing chlorate from the chlorate composition to act on polymer plugging present within the hydrocarbon bearing formation by allowing the treatment fluid to remain in the hydrocarbon bearing formation to form reacted fluid, and (iii) retrieving reacted fluid from the hydrocarbon bearing subterranean formation.

In some embodiments, the method comprises retrieving reacted fluid from the hydrocarbon bearing subterranean formation within less than 24 hours (e.g., less than 20, 18, 16, 15, 14, 12, 10, 8, 6, 5, 4, 3, or 2 hours) of the introducing of the treatment fluid into the hydrocarbon bearing subterranean formation. Generally, the reacted fluid comprises broken polyacrylamide.

In some embodiments, the method comprises retrieving reacted fluid from the hydrocarbon bearing subterranean formation. In some embodiments, the retrieving is performed more than 12 hours (e.g., more than 1 day, more than 2 days, more than 3 days, more than 5 days, more than 1 week, more than 10 days, more than 2 weeks, more than 3 weeks or more than 4 weeks following the introducing). Generally, the reacted fluid comprises broken polyacrylamide.

In some embodiments, introducing the treatment fluid into the hydrocarbon bearing subterranean formation comprises introducing (e.g., pumping) the treatment fluid into a wellbore or portion thereof that penetrates the hydrocarbon bearing subterranean formation.

In some embodiments, the wellbore or portion thereof has a temperature of less than 120° F. In some embodiments, the wellbore or portion thereof has a temperature of less than 110° F. In some embodiments, the wellbore or portion thereof has a temperature of 105° F. or less. In some embodiments, the wellbore or portion thereof has a temperature of 100° F. or less.

In some embodiments, the method further comprises selecting a wellbore or portion thereof that has a temperature of less than 120° F. In some embodiments, the method further comprises selecting a wellbore or portion thereof that has a temperature of less than 110° F. In some embodiments, the method further comprises selecting a wellbore or portion thereof that has a temperature of 105° F. or less. In some embodiments, the method further comprises selecting a wellbore or portion thereof that has a temperature of 100F or less.

In some embodiments, the wellbore has a bottom hole temperature of less than 120° F. In some embodiments, the wellbore has a bottom hole temperature of less than 110° F. In some embodiments, the wellbore has a bottom hole temperature of 105° F. or less. In some embodiments, the wellbore has a bottom hole temperature of 100° F. or less.

In some embodiments, the method further comprises shutting in the wellbore. In some embodiments, the shutting in is for at least 12 hours, 1 day, 2 days, 3 days, 5 days, 1 week, 10 days, 2 weeks, 3 weeks or 4 weeks following the introducing. In some embodiments, the method further comprises retrieving flowback fluid from the well following the shutting in. In some embodiments, the retrieving is performed between 2 days and 8 weeks (e.g., between 2 days and 8 weeks or 3 days and 8 weeks) following the introducing. Generally, the flowback fluid comprises broken polyacrylamide.

In another aspect provided herein is a method of treating polymer plugging in a hydrocarbon bearing subterranean formation, the method comprising (i) introducing a treatment fluid comprising a chlorate composition into a wellbore or portion thereof that penetrates a hydrocarbon bearing subterranean formation that has previously been treated with polyacrylamide (e.g., anionic polyacrylamide), the wellbore or portion thereof having temperature disclosed herein (e.g., a temperature less than 120° F., a temperature less than 110° F., a temperature of 105° F. or less, or a temperature of 100° F. or less) (ii) allowing the treatment fluid to act on polymer plugging present within the hydrocarbon bearing formation to form reacted fluid, and (iii) retrieving reacted fluid from the hydrocarbon bearing subterranean formation. Generally, the reacted fluid comprises broken polyacrylamide. The retrieving can comprise introducing a flushing fluid into the formation.

In some embodiments, the method comprises allowing the treatment fluid to act on the polymer plugging for a limited period of time. In such embodiments, the method comprises retrieving reacted fluid from the hydrocarbon bearing subterranean formation within less than 24 hours (e.g., less than 20, 18, 16, 14, 12, 10, 8, 6, 5, 4, 3, or 2 hours) after the introducing of the treatment fluid. In some embodiments, the retrieving comprises introducing a flushing fluid into the formation.

In some embodiments, the method comprises retrieving reacted fluid more than 12 hours (e.g., more than 1 day, more than 2 days, more than 3 days, more than 5 days, more than 1 week, more than 10 days, more than 2 weeks, more than 3 weeks or more than 4 weeks following the introducing of the treatment fluid). Generally, the reacted fluid comprises broken polyacrylamide. In some embodiments, the retrieving comprises introducing a flushing fluid into the formation.

In some embodiments of the methods disclosed herein, the chlorate composition is not applied so as to generate chlorine dioxide at temperatures in excess of 110° F.

In another aspect provided herein is a method of treating a well fluid, the method comprising

(i) mixing an aqueous base fluid with a friction reducing polymer, and optionally, an organic solvent at a concentration of up to 20% and a surfactant at a concentration of up to 10%, thereby forming a mixture having an initial viscosity, the polymer consisting of at least 60%, 70%, 75%, 80%, 85%, 90%, 95%, 96%, 97%, 98%, or 99% polyacrylamide (e.g., anionic polyacrylamide) relative to other polymers, if any,

(ii) adding dose of a chlorate composition to the mixture to form a well fluid, and

(iii) allowing chlorate from the chlorate composition to act on the polyacrylamide,

wherein the dose provides a concentration of chlorate in the well fluid sufficient to provide a decreased viscosity in the well fluid, wherein said decreased viscosity is at least 40% less (e.g., at least 45%, 50%, 55%, 60%, 65%, 70%, 75%, 80%, 85%, or 90% less) than the initial viscosity.

In some embodiments, the mixture contains polyacrylamide at a concentration of at least 10%, at least 15% or at least 20%. In some embodiments, the mixture contains polyacrylamide at a concentration of 10% to 50%, 20% to 40% or 25% to 35%.

In some embodiments, the mixture contains a concentration of at least 70%, 75%, 80%, 85%, 90%, 95%, 96%, 97%, 98%, or 99% polyacrylamide (e.g., anionic polyacrylamide) relative to other polymers, if any. In some embodiments, the mixture contains at least 90% anionic polyacrylamide relative to other polymers, if any.

In another aspect provided herein is a method comprising introducing a well treatment fluid into a hydrocarbon bearing subterranean formation, the well treatment fluid comprising polyacrylamide (e.g., anionic polyacrylamide) and a chlorate salt, wherein the chlorate salt provides a relative concentration of chlorate anion to polyacrylamide as disclosed herein (e.g., a relative concentration of at least 3%(w/w) or of 3% to 40% (w/w)). In some embodiments, the well treatment fluid comprises polyacrylamide (e.g., anionic polyacrylamide) at a concentration disclosed herein, e.g., at a concentration of at least 40 ppm. In some embodiments, the well treatment fluid has a pH greater than 4 or 4.5. In some embodiments, the well treatment fluid has a pH of 5 to 8. In some embodiments, the well treatment fluid has a pH of 6 to 8. In some embodiments, the well treatment fluid contains a concentration of at least 70%, 75%, 80%, 85%, 90%, 95%, 96%, 97%, 98%, or 99% polyacrylamide (e.g., anionic polyacrylamide) relative to other polymers, if any. In some embodiments, the well treatment fluid contains at least 90% anionic polyacrylamide relative to other polymers, if any. In some embodiments, the well treatment fluid contains at least 80%, 95%, 90% or 95% by weight chlorate anions relative to total weight of other breaker anions. In some embodiments, the well treatment fluid contains at least 80%, 95%, 90% or 95% by weight chlorate anions relative to total weight of persulfate anions, chlorite anions, and peroxide anions in the well treatment fluid, if any.

In another aspect provided herein is a method of making a well treatment fluid, the method comprising mixing well treatment components to form a well treatment fluid, the well treatment components including (a) an aqueous base fluid, (b) a friction reducer comprising polyacrylamide (e.g., anionic polyacrylamide), and (c) a chlorate composition. In some embodiments, the method further comprises introducing the well treatment fluid into a wellbore penetrating a hydrocarbon bearing subterranean formation. In some embodiments, the chlorate composition provides a relative concentration of (w/w) chlorate anion to polyacrylamide (e.g., anionic polyacrylamide) as disclosed herein in the well treatment fluid. In one embodiment, the chlorate composition provides a relative concentration of at least 3% (w/w) chlorate anion to polyacrylamide (e.g., anionic polyacrylamide) in the well treatment fluid. In some embodiments, the chlorate composition provides a relative concentration of 3% to 40%, 5% to 35% or 10% to 40% (w/w) chlorate anion to polyacrylamide (e.g., anionic polyacrylamide) in the well treatment fluid. In some embodiments, the well treatment fluid comprises polyacrylamide (e.g., anionic polyacrylamide) at a concentration disclosed herein, e.g., at a concentration of at least 40 ppm. In some embodiments, the well treatment fluid has a pH greater than 4 or greater than 4.5. In some embodiments, the well treatment fluid has a pH of 5 to 8. In some embodiments, the well treatment fluid has a pH of 6 to 8.

In some embodiments, the well treatment fluid is applied for an initial completion, e.g., a fracturing operation. In some embodiments, the well treatment fluid is introduced into the hydrocarbon bearing formation at a flow rate and pressure sufficient to fracture the formation.

In some embodiments, the well treatment components include a proppant (e.g., sand). In some embodiments, the well treatment components include one or more other components disclosed herein.

In some embodiments, the introducing is within 20 min. of the mixing. In some embodiments, the introducing is within 15 min. of the mixing. In some embodiments, the introducing is within 10 min. of the mixing. In some embodiments, the introducing is within 5 min. of the mixing. In some embodiments, the introducing is within 3 min., 2 min. or 1 min. of the mixing.

In some embodiments, the friction reducer comprises 10% to 90% polyacrylamide, e.g., anionic polyacrylamide. In some embodiments, the friction reducer comprises 5 to 50%, 20% to 40%, 20 to 35%, or 25% to 35% polyacrylamide, e.g., anionic polyacrylamide. In some embodiments, the friction reducer comprises 20% to 40% anionic polyacrylamide. In some embodiments, the friction reducer comprises 20% to 35% anionic polyacrylamide. In some embodiments, the friction reducer is in the form of an emulsion.

In some embodiments, the friction reducer is included in the well treatment fluid at an amount of 0.25 to 1 gallon per thousand gallons of base fluid.

In some embodiments, the friction reducer is mixed with the other components of the well treatment fluid so as to provide a concentration of polyacrylamide (e.g., anionic polyacrylamide) disclosed herein.

In some embodiments, the well treatment fluid comprises at least 40 ppm (e.g., 40 to 1000 ppm, 50 to 800 ppm or 50 to 600 ppm) polyacrylamide (e.g., anionic polyacrylamide),In some embodiments, the well treatment fluid contains a concentration of at least 70%, 75%, 80%, 85%, 90%, 95%, 96%, 97%, 98%, or 99% polyacrylamide (e.g., anionic polyacrylamide) relative to other polymers, if any. In some embodiments, the well treatment fluid contains at least 90% anionic polyacrylamide relative to other polymers, if any.

In some embodiments, the well treatment fluid contains at least 80%, 85%, 90% 95%, 96%, 97%, 98%, or 99% by weight chlorate anions relative to total weight of other breaker anions.

In some embodiments, the well treatment fluid contains at least 80%, 85%, 90%, 95%, 96%, 97%, 98%, or 99% by weight chlorate anions relative to total weight of persulfate anions, chlorite anions, and peroxide anions, if any. In some embodiments, the well treatment fluid contains at least 90% by weight chlorate anions relative to total weight of persulfate anions, chlorite anions, and peroxide anions, if any.

In some embodiments, the methods disclosed herein further comprise retrieving fluid comprising broken polyacrylamide (e.g., anionic polyacrylamide) from the hydrocarbon bearing subterranean formation. In some embodiments, the retrieving comprises introducing a flushing fluid into the formation.

In some embodiments, the retrieving is performed within less than 24 hours (e.g., less than 20, 18, 16, 14, 12, 10, 8, 6, 5, 4, 3, or 2 hours) after the introducing.

In another aspect provided herein is a method of treating a hydrocarbon bearing formation, the method comprising mixing well treatment components to form a well treatment fluid, the well treatment components including (a) an aqueous base fluid, (b) a friction reducer comprising polyacrylamide (e.g., anionic polyacrylamide), and (c) a chlorate composition that provides a relative concentration of chlorate to polyacrylamide (e.g., anionic polyacrylamide) that is sufficient to reduce the initial viscosity of the well treatment fluid by at least 40%, wherein the well treatment fluid has a pH greater than 4. In some embodiments, the method further comprises introducing the well treatment fluid into a wellbore penetrating a hydrocarbon bearing subterranean formation.

In some embodiments, the friction reducer comprises 10% to 90% polyacrylamide, e.g., anionic polyacrylamide. In some embodiments, the friction reducer comprises 5 to 50%, 20% to 40%, 20 to 35%, or 25% to 35% polyacrylamide, e.g., anionic polyacrylamide. In some embodiments, the friction reducer comprises 20% to 40% polyacrylamide (e.g., anionic polyacrylamide). In some embodiments, the friction reducer comprises 20% to 35% anionic polyacrylamide. In some embodiments, the friction reducer is in the form of an emulsion.

In some embodiments, the friction reducer is included in the well treatment fluid at an amount of 0.25 to 1 gallon per thousand gallons of base fluid.

In some embodiments, the friction reducer is mixed with the other components of the well treatment fluid so as to provide a concentration of polyacrylamide (e.g., anionic polyacrylamide) disclosed herein.

In some embodiments, the well treatment fluid comprises at least 40 ppm (e.g., 40 to 1000 ppm, 50 to 800 ppm or 50 to 600 ppm) polyacrylamide (e.g., anionic polyacrylamide).

In some embodiments, the well treatment components include a proppant (e.g., sand).

In some embodiments, the introducing is within 20 min. of the mixing. In some embodiments, the introducing is within 15 min. of the mixing. In some embodiments, the introducing is within 10 min. of the mixing. In some embodiments, the introducing is within 5 min. of the mixing. In some embodiments, the introducing is within 3 min., 2 min. or 1 min. of the mixing.

In some embodiments, the introducing is performed within a period of time such that the initial viscosity of the well treatment fluid (as determined immediately following mixing) has not decreased by more than 10% at the time of the introducing. In some embodiments, the introducing is performed within a period of time such that the initial viscosity of the well treatment fluid has not decreased by more than 5% at the time of the introducing.

In some embodiments, the well treatment fluid has a pH greater than 4.5. In some embodiments, the well treatment fluid has a pH of 5 to 8. In some embodiments, the well treatment fluid has a pH of 6 to 8.

In some embodiments, the well treatment components include a proppant (e.g., sand). In some embodiments, the well treatment components include one or more other components disclosed herein.

In some embodiments, the friction reducer comprises 10% to 90% polyacrylamide, e.g., anionic polyacrylamide. In some embodiments, the friction reducer contains polyacrylamide, e.g., anionic polyacrylamide, at a concentration of at least 10%, at least 15% or at least 20%. In some embodiments, the friction reducer comprises 5% to 90%, 10% to 90%, 20% to 90%, 20% to 40%, or 25% to 35% polyacrylamide, e.g., anionic polyacrylamide. In some embodiments, the friction reducer comprises 20% to 40% anionic polyacrylamide. In some embodiments, the friction reducer comprises 25% to 35% anionic polyacrylamide. In some embodiments, the friction reducer is in the form of an emulsion.

In some embodiments, the well treatment fluid contains a concentration of at least 70%, 75%, 80%, 85%, 90%, 95%, 96%, 97%, 98%, or 99% polyacrylamide (e.g., anionic polyacrylamide) relative to other polymers, if any. In some embodiments, the well treatment fluid contains at least 90% anionic polyacrylamide relative to other polymers, if any.

In some embodiments, the well treatment fluid contains at least 80%, 85%, 90% 95%, 96%, 97%, 98%, or 99% by weight chlorate anions relative to total weight of other breaker anions.

In some embodiments, the well treatment fluid contains at least 80%, 85%, 90% or 95%, 96%, 97%, 98%, or 99% by weight chlorate anions relative to total weight of persulfate anions, chlorite anions, perborate anions and peroxide anions, if any. In some embodiments, the well treatment fluid contains at least 90% by weight chlorate anions relative to total weight of persulfate anions, chlorite anions, and peroxide anions, if any.

In some embodiments, the methods disclosed herein further comprise retrieving fluid comprising broken polyacrylamide (e.g., anionic polyacrylamide) from the hydrocarbon bearing subterranean formation. In some embodiments, the retrieving comprises introducing a flushing fluid into the formation.

In some embodiments, the methods disclosed herein comprise shutting in the well before retrieving the fluid comprising broken polyacrylamide. The shutting in is generally after the well treatment fluid (or combination fluid) is introduced.

In some embodiments, the shutting in is for a period of at least at least 12 hours, 1 day, 2 days, 3 days, 5 days, 1 week, 10 days, 2 weeks, 3 weeks or 4 weeks.

In some embodiments, the retrieving is performed within less than 24 hours (e.g., less than 20, 18, 16, 14, 12, 10, 8, 6, 5, 4, 3, or 2 hours) after the introducing.

In some embodiments, the well treatment fluid components include other components that are useful, e.g., in hydraulic fracturing fluids or other well treatment fluids.

In some embodiments, a well treatment fluid (or combined fluid or mixture) disclosed herein further comprises a corrosion inhibitor, a pH control additive, a surfactant, a fluid loss control additive, a scale inhibitor, an asphaltene inhibitor, a paraffin inhibitor, a biocide, a fluid stabilizer, a chelant, a foaming agent, a defoamer, an emulsifier, a deemulsifier, an iron control agent, an alcohol solvent, a mutual solvent, an oxygen scavenger, a particulate diverter, an activator, a retarder, or a combination of two or more thereof

In some embodiments, a well treatment fluid (or combined fluid or mixture) disclosed herein comprises a relative concentration of at least 70%, 75%, 80%, 85%, 90%, 95%, 96%, 97%, 98%, or 99% chlorate anion by weight relative to the total weight of any other breaker anions included in the well treatment fluid. Other breaker anions can include, e.g., persulfate, chlorite, hypochlorite, perborate and peroxide.

In another aspect provided herein is a method comprising mixing well treatment components to form a well treatment fluid, the well treatment components including (a) an aqueous base fluid, (b) anionic polyacrylamide (or a friction reducer comprising anionic polyacrylamide), and (c) a chlorate composition that provides a relative concentration of 3% to 40% (w/w) chlorate anion to anionic polyacrylamide in the well treatment fluid, wherein the well treatment fluid initially comprises at least 40 ppm anionic polyacrylamide and has a pH of 5 to 8.

In some embodiments, the aqueous base fluid, the anionic polyacrylamide, and the chlorate composition are mixed concurrently. In some embodiments, the aqueous base fluid, the anionic polyacrylamide, and the chlorate composition are mixed concurrently in a blender.

The well treatment components can also be mixed sequentially. For example, the chlorate composition can be mixed with the aqueous base fluid before these components are mixed with the anionic polyacrylamide. In another example, the aqueous base fluid can be mixed with the anionic polyacrylamide (or a fricition reducer comprising the anionic polyacrylamide) before these components are mixed with the chlorate composition.

In some embodiments, the well treatment components comprise a proppant.

In some embodiments, the well treatment fluid contains a proportion of at least 70%, 75%, 80%, 85%, 90%, 95%, 96%, 97%, 98%, or 99% polyacrylamide (e.g., anionic polyacrylamide) relative to other polymers, if any. In some embodiments, the well treatment fluid contains a proportion of at least 90% anionic polyacrylamide relative to other polymers, if any.

In some embodiments, the well treatment fluid contains at least 80%, 85%, 90% 95%, 96%, 97%, 98%, or 99% by weight chlorate anions relative to total weight of other breaker anions. In some embodiments, the well treatment fluid contains at least 90% by weight chlorate anions relative to total weight of other breaker anions included in the well treatment fluid, if any.

Also provided herein are well treatment fluids made according to these methods.

### Chlorate Compositions

The chlorate composition is a source of chlorate ion. The chlorate composition generally comprises a chlorate salt. Typically, the chlorate salt comprises sodium chlorate. In some embodiments, the chlorate salt comprises sodium chlorate, potassium chlorate, calcium chlorate, magnesium chlorate or a combination thereof.

In some embodiments, the chlorate composition consists essentially of the chlorate salt. In some embodiments, the chlorate composition consists essentially of sodium chlorate.

The chlorate composition can comprise the chlorate salt in solid form or in solution.

In some embodiments, the chlorate composition comprises a solid chlorate salt. In some embodiments, the chlorate composition comprises a solution (e.g., an aqueous solution) comprising a chlorate salt. In some embodiments, the solution comprises 5-60%, 5-50%, 10-45% or 10-30% of a chlorate salt.

In some embodiments, the chlorate composition comprises solid sodium chlorate or a solution (e.g., an aqueous solution) of sodium chlorate. In some embodiments, the solution comprises 5-60%, 5-50%, 10-45% or 10-30% of sodium chlorate. In some embodiments, the solution of sodium chlorate has a pH of greater than 4, of greater than 5, or of greater than 6. In some embodiments, the solution of sodium chlorate has a pH of 5 to 8. In some embodiments, the solution of sodium chlorate has a pH of 6 to 8.

In some embodiments, the chlorate composition has a pH of greater than 4, of greater than 5, or of greater than 6. In some embodiments, the chlorate composition has a pH of 5 to 8. In some embodiments, the chlorate composition has a pH of 6 to 8.

In some embodiments, the chlorate composition further comprises an acid (e.g., an acid in solid form or in solution). In some embodiments, the chlorate composition comprises up to 2% (e.g., 0.1-2% or 0.1 to 1%) of a strong acid and/or up to 20% (e.g., up to 15% or up to 10%) of a weak acid. The weak acid can be, e.g., citric acid, lactic acid, acetic acid, or propionic acid. In an aspect of such embodiments, the chlorate composition has a pH of greater than 4, of greater than 5, or of greater than 6. In further aspects of such embodiments, the chlorate composition has a pH of 5 to 8.

In some embodiments, the chlorate composition has a pH of 6 to 8.

In some embodiments, the type and concentration of acid included in the chlorate composition, if any, is selected such that the acid does not react with the chlorate salt included in the composition at a temperature less than 110° F. In this context, that the acid does not react means that the acid and the chlorate salt in the chlorate composition, when the chlorate composition is at a temperature less than 110° F., do not react to form detectable chlorine dioxide. Chlorine dioxide (as well as other chlorine compounds such as chlorite and chlorate) can be detected using conventional means, preferably iodometric titration.

In some embodiments, the chlorate composition does not comprise an acid.

In some embodiments, the chlorate composition comprises no acid or comprises less than a stoichiometric amount of an acid. As used herein, a “stoichiometric amount” of an acid would provide an amount of hydrogen ion to allow a stoichiometric reaction of the chlorate to form chlorine dioxide.

In some embodiments, the chlorate composition comprises one or more conventional breakers. In some embodiments, the chlorate composition comprises a proportion of at least 70%, 75%, 80%, 85%, 90%, 95%, 96%, 97%, 98%, or 99% chlorate anion by weight relative to the total weight of anions from one or more conventional breakers. Conventional breakers include, e.g., persulfates, chlorite, and peroxides (e.g., hydrogen peroxide). In some embodiments, said one or more conventional breakers is persulfate, chlorite, or peroxide.

In some embodiments, the chlorate composition is encapsulated. Subvolumes of the total chlorate composition can be encapsulated to form a chlorate composition having a plurality of capsules containing chlorate composition. Encapsulation allows the chlorate to be released at a delay. Encapsulation can be useful in applications in which it is desirable to decrease fluid viscosity at a delay. For example, in hydraulic fracturing applications it is generally desirable to initially maintain a viscosity in the fracturing fluid that is sufficient to hold proppant in suspension and to later decrease the viscosity to allow removal of the fracturing fluid and production of hydrocarbon through the fractures created.

The chlorate composition can be encapsulated with any suitable encapsulation method or encapsulation material that does not adversely interact with or chemically react with the chlorate employed in the composition. Many encapsulation methods and materials are known. Examples of such methods and materials are described, for instance, in U.S. Pat. No. 4,741,401, U.S. Pat. No. 4,919,209, U.S. Pat. No. 5,164,099, U.S. Pat. No. 5,373,901, U.S. Pat. No. 6,444,316, U.S. Pat. No. 6,527,051, U.S. Pat. No. 6,554,071, U.S. Pat. No. 6,840,318, U.S. 2019/0062620, CA2346324, EP1166866B1, WO 1992/012328.

In some embodiments, the chlorate composition is not encapsulated.

### Polyacrylamide and Polyacrylamide Compositions

As used herein, “polyacrylamide” refers to a polymer formed from acrylamide monomers. In some embodiments, the polyacrylamide is polyacrylamide from a polyacrylamide composition, which may contain other components in addition to polyacrylamide.

As used herein, a “polyacrylamide composition” refers to a composition that comprises or consists of polyacrylamide. The composition can be, e.g., a solvated or dry composition. Such a polyacrylamide composition can be, e.g., a friction reducer, viscosifying agent, or soil conditioner. Such compositions are commercially available. In some embodiments, the polyacrylamide composition is suitable for use as a friction reducer. In some embodiments, the polyacrylamide composition contains additional polymers and/or non-polymer components.

In some embodiments, the polyacrylamide composition contains a polymer (which can be a polymer mixture) that consists essentially of a polyacrylamide as disclosed herein. Accordingly, the polymer, when solvated (e.g., hydrated), is susceptible to viscosity reducing effects of treatment with chlorate, which can be verified under conditions disclosed herein.

In some embodiments, the polyacrylamide composition contains a polymer (which can be a polymer mixture) that consists of at least 50% 60%, 70%, 80%, 90%, 95%, 97%, 98%, or 99% polyacrylamide (e.g., a polyacrylamide disclosed herein, e.g., anionic polyacrylamide).

In some embodiments, the polyacrylamide composition is suitable for use as a friction reducer.

In some embodiments, the polyacrylamide composition is a friction reducer. In some embodiments, the friction reducer contains a concentration of at least 70%, 75%, 80%, 85%, 90%, 95%, 96%, 97%, 98%, or 99% polyacrylamide (e.g., anionic polyacrylamide) relative to other polymers, if any.

In some embodiments, the polyacrylamide composition (e.g., the friction reducer) is in the form of an emulsion (e.g., an oil in water emulsion or a water in oil emulsion).

As used herein, a “solvated polyacrylamide composition” refers to a polyacrylamide composition that is solvated (e.g., hydrated) in a fluid (or a base fluid). Typically, the base fluid is predominantly water (more than 50% water, e.g., at least 55%, 60%, 65%, 70%, 75%, 80%, 85%, 90% or 95% water). The base fluid can also can contain non-aqueous components. In some embodiments, the base fluid comprises produced water. In some embodiments, the base fluid comprises a brine. In some embodiments, the base fluid contains 1% or less of a salt, such as sodium chloride or potassium chloride. In some embodiments, the polyacrylamide has an average molecular weight of at least 10⁵ Da. In some embodiments, the polyacrylamide has an average molecular weight of at least 10⁶ Da. In some embodiments, the polyacrylamide has an average molecular weight of 10⁵ to 10⁷ Da. In some embodiments, the polyacrylamide has an average molecular weight of 10⁵ to 10⁸ Da. In some embodiments, the polyacrylamide has an average molecular weight of 10⁶ to 10⁷ Da. In some embodiments, the polyacrylamide has an average molecular weight of 10⁶ to 5×10⁷ Da. In some embodiments, the polyacrylamide has an average molecular weight of 5×10⁶ to 10⁸ Da.

In some embodiments, the polyacrylamide is predominantly linear (greater than 50% linear, e.g., at least 60%, 70%, 80%, 90%, 95%, 97%, 98%, or 99% of the polyacrylamide is linear). In some embodiments, the polyacrylamide is linear.

The polyacrylamide can be, e.g., non-ionic, anionic, or cationic.

In some embodiments, the polyacrylamide comprises anionic polyacrylamide. The anionic polyacrylamide can be, e.g., poly-acrylamido-2-methylpropane sulfonate or hydrolyzed polyacrylamide (also known as polyacrylamide-co-acrylic acid). In some embodiments, the polyacrylamide comprises poly-acrylamido-2-methylpropane sulfonate.

In some embodiments, the anionic polyacrylamide is predominantly linear (greater than 50% linear). In some embodiments, at least 60%, 70%, 80%, 90%, 95%, 97%, 98%, or 99% of the polyacrylamide is linear. In some embodiments, the anionic polyacrylamide is linear.

In some embodiments, the polyacrylamide comprises cationic polyacrylamide. The cationic polyacrylamide can be, e.g., poly(acrylamide-co-diallyldimethylammonium)poly(AM-co-DADMAC) or poly(acrylamide-co-N,N,N-trimethyl-2-((1-oxo-2-propenyl)oxy)).

In some embodiments, the polyacrylamide comprises non-ionic polyacrylamide.

### Relative Concentrations of Chlorate to Polyacrylamide

In some embodiments, the chlorate composition is administered in proportion to the polyacrylamide so as to provide a relative concentration of at least 0.4%, 1%, 2%, 3%, 4%, 5%, 8% or 10% (w/w) chlorate (anion) to polyacrylamide. In some embodiments, the chlorate composition is administered so as to provide a relative concentration of up to 50% (w/w) chlorate (anion) to polyacrylamide. In some embodiments, the chlorate composition is administered so as to provide a relative concentration of up to 40% (w/w) chlorate (anion) to polyacrylamide. In some embodiments, the chlorate composition is administered so as to provide a relative concentration of up to 35% (w/w) chlorate (anion) to polyacrylamide.

In some embodiments, the chlorate composition is administered so as to provide a relative concentration of 0.5% to 50% (w/w) chlorate (anion) to polyacrylamide. In some embodiments, the chlorate composition is administered so as to provide a relative concentration of 1% to 50% (w/w) chlorate (anion) to polyacrylamide. In some embodiments, the chlorate composition is administered so as to provide a relative concentration of 3% to 50% (w/w) chlorate (anion) to polyacrylamide. In some embodiments, the chlorate composition is administered so as to provide a relative concentration of 5% to 50% (w/w) chlorate (anion) to polyacrylamide.

In some embodiments, the chlorate composition is administered so as to provide a relative concentration of 3% to 40% (w/w) chlorate (anion) to polyacrylamide. In some embodiments, the chlorate composition is administered so as to provide a relative concentration of 4% to 40% (w/w) chlorate (anion) to polyacrylamide. In some embodiments, the chlorate composition is administered so as to provide a relative concentration of 5% to 40% (w/w) chlorate (anion) to polyacrylamide. In some embodiments, the chlorate composition is administered so as to provide a relative concentration of 8% to 40% (w/w) chlorate (anion) to polyacrylamide. In some embodiments, the chlorate composition is administered so as to provide a relative concentration of 10% to 40% (w/w) chlorate (anion) to polyacrylamide.

In some embodiments, the chlorate composition is administered so as to provide a relative concentration of 3% to 35% (w/w) chlorate (anion) to polyacrylamide. In some embodiments, the chlorate composition is administered so as to provide a relative concentration of 5% to 35% (w/w) chlorate (anion) to polyacrylamide.

In some embodiments, the chlorate composition is administered so as to provide a relative concentration of 5% to 30% (w/w) chlorate (anion) to polyacrylamide. In some embodiments, the chlorate composition is administered so as to provide a relative concentration of 10% to 30% (w/w) chlorate (anion) to polyacrylamide.

In some embodiments, the chlorate composition is administered in proportion to the polyacrylamide so as to provide a viscosity reduction of at least 15% (e.g., a viscosity reduction of at least 20%, 25%, 30%, 35%, 40%, 45% 50%, 55%, 60%, 65%, 70%, 75%, 80%, 85%, or 90%).

### Well Treatment Compositions

Also provided herein are well treatment compositions comprising polyacrylamide and chlorate. In some embodiments, the polyacrylamide is anionic polyacrylamide. The compositions can include other components or features disclosed herein.

In some embodiments, the well treatment composition is made according to a method disclosed herein.

In one aspect provided herein is a well treatment fluid comprising polyacrylamide and a chlorate salt in an amount that provides a relative concentration of chlorate (anion) to polyacrylamide as disclosed herein. In some embodiments, the relative concentration is at least 0.4%, 1%, 2%, 3%, 4%, 5%, 8% or 10% (w/w). In some embodiments, relative concentration is up to 50% (w/w). In some embodiments, relative concentration is up to 40% (w/w). In some embodiments, relative concentration is up to 35% (w/w).

In some embodiments, the relative concentration is 0.5% to 50% (w/w). In some embodiments, the relative concentration is 1% to 50%(w/w). In some embodiments, the relative concentration is 3% to 50% (w/w). In some embodiments, the relative concentration is 5% to 50% (w/w). In some embodiments, the relative concentration is 3% to 40% (w/w). In some embodiments, the relative concentration is 4% to 40% (w/w). In some embodiments, the relative concentration is 5% to 40% (w/w). In some embodiments, the relative concentration is 8% to 40% (w/w). In some embodiments, the relative concentration is 10% to 40% (w/w). In some embodiments, the relative concentration is 3% to 35% (w/w). In some embodiments, the relative concentration is 5% to 35% (w/w) chlorate (anion) to polyacrylamide. In some embodiments, the relative concentration is 5% to 30% (w/w). In some embodiments, the relative concentration is 10% to 30% (w/w).

In some embodiments, the initial viscosity of the well treatment fluid is 2 cP to 70 cP, 5 cP to 70 cP, or 10 cP to 60 cP.

In some embodiments, the chlorate decreases the viscosity of the well treatment fluid by at least 15%, 20%, 25%, 30%, 35%, 40%, 45%, 50%, 55%, 60%, 65%, 70%, 75%, 80%, 85%, or 90% relative to the viscosity of an otherwise corresponding well treatment fluid that does not comprise the chlorate salt. In some embodiments, the well treatment fluid has a pH greater than 4. In some embodiments, the well treatment fluid has a pH of 4 to 8. In some embodiments, the well treatment fluid has a pH of 5 to 8. In some embodiments, the well treatment fluid has a pH of 6 to 8.

In some embodiments, the chlorate salt is sodium chlorate, potassium chlorate, calcium chlorate, magnesium chlorate or a combination thereof. In some embodiments, the chlorate salt is sodium chlorate. In some embodiments, a well treatment fluid (or combined fluid or mixture that is introduced or for introduction into a hydrocarbon bearing subterranean formation) disclosed herein comprises a relative concentration of at least 70%, 75%, 80%, 85%, 90%, 95%, 96%, 97%, 98%, or 99% chlorate anion by weight relative to the total weight of any other breaker anions included in the well treatment fluid. Other breaker anions can be breaker anions disclosed herein or known in the art.

In some embodiments, a well treatment fluid comprises at least 70%, 75%, 80%, 85%, 90%, 95%, 96%, 97%, 98%, or 99% chlorate anion relative to total weight of persulfate, chlorite, perborate and peroxide anions, if any, in the well treatment fluid.

In some embodiments, the polyacrylamide is anionic polyacrylamide. In some embodiments, the polyacrylamide is suitable for use as a friction reducer. In some embodiments, any polymer included in the well treatment fluid comprises 50% or more anionic polyacrylamide (e.g., at least 55%, 60%, 70%, 80%, 90% or 95%) relative to other polymers, if any. In some embodiments, the well treatment fluid contains less than 10% guar or guar derivatives (0 to 10% guar or guar derivatives), relative to other polymers. In some embodiments, the well treatment fluid contains less than 5% guar or guar derivatives (0 to 5% guar or guar derivatives), relative to other polymers. In some embodiments, the well treatment fluid does not contain added guar or guar derivatives. In some embodiments, the well treatment fluid does not contain guar or guar derivatives.

In some embodiments, the well treatment fluid comprises at least 10 ppm, 20 ppm, 25 ppm, 30 ppm, 40 ppm, or 50 ppm polyacrylamide (e.g., anionic polyacrylamide). In some embodiments, the well treatment fluid comprises up to 500 ppm, 600 ppm, 800 ppm 1000 ppm, 5000 ppm, or 10,000 ppm polyacrylamide (e.g., anionic polyacrylamide).

In some embodiments, the well treatment fluid comprises at least 40 ppm polyacrylamide (e.g., anionic polyacrylamide). In some embodiments, the well treatment fluid comprises 40 to 1000 ppm polyacrylamide (e.g., anionic polyacrylamide). In some embodiments, the well treatment fluid comprises 50 to 800 ppm polyacrylamide (e.g., anionic polyacrylamide).

In some embodiments, the well treatment fluid comprises 40 to 800 ppm, 40 to 600 ppm or 40 to 500 ppm polyacrylamide (e.g. anionic polyacrylamide). In some embodiments, the well treatment fluid comprises 50 to 600 ppm or 50 to 500 ppm polyacrylamide (e.g., anionic polyacrylamide).

In some embodiments, the well treatment fluid does not comprise an acid.

In some embodiments, the well treatment fluid comprises no acid or comprises less than a stoichiometric amount of an acid. As used herein, a “stoichiometric amount” of an acid would provide an amount of hydrogen ion to allow a stoichiometric reaction of the chlorate to form chlorine dioxide. In another aspect provided herein is a well treatment fluid made by combining (e.g., mixing) (i) a friction reducer containing polyacrylamide (ii) a chlorate composition comprising a chlorate salt, and optionally, (iii) an aqueous base fluid and/or one or more other components disclosed herein.

In some embodiments, the friction reducer comprises at least 10%, 20% or 25% by weight of a polyacrylamide, e.g., anionic polyacrylamide. In some embodiments, any polymer included in the friction reducer comprises 50% or more anionic polyacrylamide (e.g., at least 55%, 60%, 70%, 80%, 90%). In some embodiments, the friction reducer is in the form of an emulsion (e.g., an oil in water emulsion or a water in oil emulsion). In some embodiments, the friction reducer is a dry composition. In some embodiments, the friction reducer includes a surfactant.

In some embodiments, a well treatment fluid disclosed herein includes other components that are useful in hydraulic fracturing fluids or other well treatment fluids. In some embodiments, a well treatment fluid (such as a hydraulic fracturing fluid) includes a proppant, e.g., sand. In some embodiments, a well treatment fluid disclosed herein comprises a corrosion inhibitor, a pH control additive, a surfactant, a fluid loss control additive, a scale inhibitor, an asphaltene inhibitor, a paraffin inhibitor, a biocide, a fluid stabilizer, a chelant, a foaming agent, a defoamer, an emulsifier, a deemulsifier, an iron control agent, an alcohol solvent, a mutual solvent, an oxygen scavenger, a particulate diverter, an activator, a retarder, or a combination of two or more thereof.

In some embodiments, a well treatment fluid (or combined fluid that is introduced or for introduction into a hydrocarbon bearing subterranean formation) disclosed herein comprises a relative concentration of at least 70%, 75%, 80%, 85%, 90%, 95%, 96%, 97%, 98%, or 99% chlorate anion by weight relative to the total weight of any other breaker anions included in the well treatment fluid. Other breaker anions include, e.g., persulfate, chlorite, peroxide, perborate, bromate, periodates, and permanganate.

In some embodiments, the well treatment fluid is made from a base fluid that comprises salt. In some embodiments, the well treatment fluid contains 2% or less of a salt. In some embodiments, the well treatment fluid contains 1% or less of a salt. In some embodiments, the salt is one or more of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In embodiments, the salt is one or more of potassium chloride, sodium chloride, calcium chloride, potassium bromide, sodium bromide, calcium bromide, zinc bromide, ammonium chloride, potassium phosphate, sodium formate, potassium formate, cesium formate, ethyl formate, methyl formate, methyl chloro formate, triethyl orthoformate, and trimethyl orthoformate. In some embodiments, the salt is a mixture of two or more of the foregoing salts.

In some embodiments, the salt comprises potassium chloride, sodium chloride, calcium chloride, potassium bromide, sodium bromide, calcium bromide, or zinc bromide. In embodiments, the salt is selected from the group consisting of potassium chloride, sodium chloride, calcium chloride, potassium bromide, sodium bromide, calcium bromide, and zinc bromide. In some embodiments, the salt is a mixture of two or more of the foregoing salts.

Also provided herein is a method of treating a hydrocarbon bearing subterranean formation, the method comprising introducing a well treatment fluid disclosed herein into the hydrocarbon bearing subterranean formation. The method can include other steps or features disclosed herein. In some embodiments, the method comprises retrieving fluid comprising broken polyacrylamide from the hydrocarbon bearing formation.

In some embodiments, the retrieving is performed within less than 24 hours (e.g., less than 20, 18, 16, 14, 12, 10, 8, 6, 5, 4, 3, or 2 hours) after the introducing.

In some embodiments, the retrieving is performed more than 12 hours (e.g., more than 1 day, more than 2 days, more than 3 days, more than 5 days, more than 1 week, more than 10 days, more than 2 weeks, more than 3 weeks or more than 4 weeks) following the introducing of the treatment fluid. Generally, the reacted fluid comprises broken polyacrylamide. In some embodiments, the retrieving comprises introducing a flushing fluid into the formation.

While this invention has been particularly shown and described with references to example embodiments thereof, it will be understood by those skilled in the art that various changes in form and details may be made therein without departing from the scope of the invention encompassed by the appended claims.

### EXAMPLES

### Example 1

### Chlorate Composition Produces Improved Viscosity Reduction Compared with Persulfate for a Polyacrylamide Composition

The experiments described in this Example investigated viscosity modifying effects of a chlorate composition and persulfate on a polyacrylamide composition at ambient temperature. As used herein, “ambient temperature” means a temperature of about 68-75° F. or 20-24° C., and in the Examples, unless otherwise specified, the ambient temperature was approximately 74° F.).

### Methods

### Solvation of Polyacrylamide

The polyacrylamide composition was solvated using the following procedure. The polyacrylamide composition (a commercial friction reducer composition containing about 30% anionic polyacrylamide, along with 15-20% petroleum distillate, <2% ammonium chloride and <2% oleic acid diethanolamide) was drawn into a syringe and injected into 600 mL of deionized (DI) water in a jar. The solution was drawn back into the syringe and flushed back out into the jar four times. The solution was mixed vigorously by spinning at 700 rpm using a drill press impeller for 1 minute. The solution was then allowed to sit for 9 minutes. The solution was then mixed again by spinning at 700 rpm for 1 minute. The solvated polyacrylamide composition was then immediately treated as described herein.

### Treatments

Persulfate was compared with a chlorate composition. The persulfate was a dry form of sodium persulfate (Fisher Scientific, Na₂S₂O₈>98%). The chlorate composition was an aqueous solution of 31% (w/w) sodium chlorate and 9% (w/w) citric acid. A breaker composition (the persulfate or chlorate composition) was added to the solvated polyacrylamide composition using a micropipette. The combined composition was stirred vigorously with a glass stir rod for 20 seconds. Several doses of breaker to solvated polyacrylamide composition were tested: 1:0.5, 1:1, 1:1.5, 1:2, and 1:2.5 (v/v ratios). A control composition was prepared in the same manner except that a comparable volume of water containing no breaker was added instead of breaker.

### Viscosity Measurements

An initial viscosity measurement was taken immediately (this timepoint was approximately 10 min after solvation and is labelled as 10 min. on the graphs showing the results) and every 2 minutes for 26 minutes (total of 14 viscosity measurements). All viscosity measurements were taken using a Brookfield spindle viscometer at 60 RPM. Viscosity reduction was calculated as the percentage change between the viscosity in the control and the relevant experimental condition.

### Results

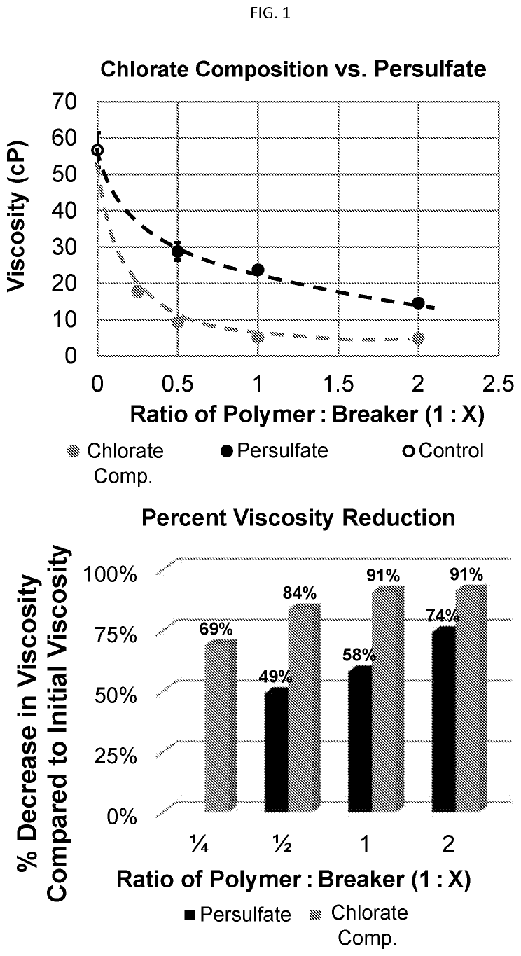

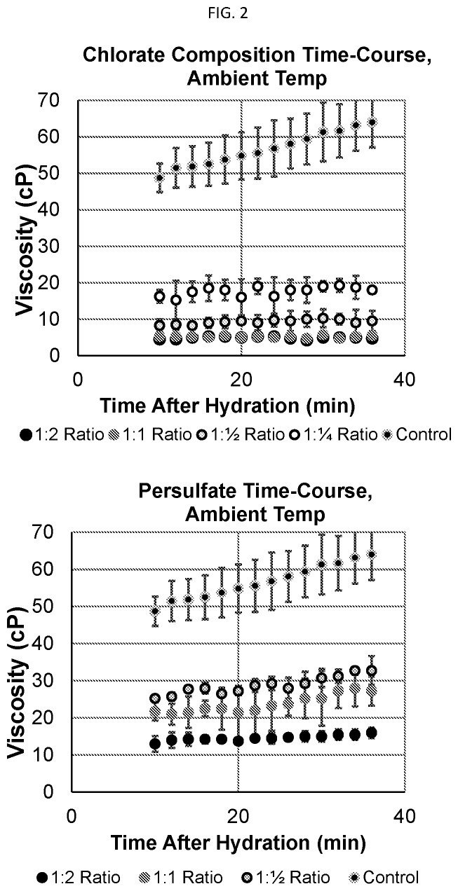

Results are presented in FIG. 1 and FIG. 2.

The top graph in FIG. 1 shows the dose response (average across timepoints). The bottom graph in FIG. 1 shows the average viscosity reduction achieved by treatments with persulfate and the chlorate composition. FIG. 2 shows the viscosity results as a function of time for the chlorate composition (top graph) and the persulfate (bottom graph).

These results show that at ambient temperature the chlorate composition reduced the viscosity of the polyacrylamide composition by about 70% to 90% (see FIG. 1, bottom graph). The results also show that the chlorate composition consistently outperformed the persulfate. As an example, at the 1:1 ratio the chlorate composition achieved 91% viscosity reduction, whereas the persulfate achieved only 58% viscosity reduction.

### Example 2

### Temperature Dependence of Breaker Performance

The effect of elevated temperature on viscosity reduction provided by the chlorate composition and persulfate was investigated using the same friction reducer as in Example 1.

### Methods

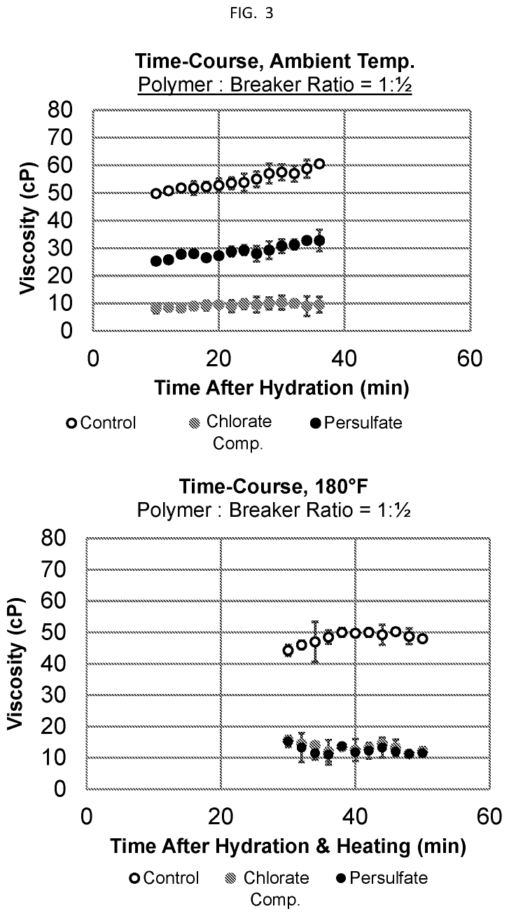

The methods were essentially the same as in Example 1, except that elevated temperature condition was included in which the combined breaker-polymer solution or control solution was heated to a temperature of 180° F. A polymer to breaker ratio of 1:0.5 (v/v) was tested. To allow time for heating, viscosity testing in the elevated temperature condition was carried out at later timepoints (as indicated in FIG. 3).

### Results

Results are shown in FIG. 3 and Table 1.

TABLE 1
Average viscosity reduction achieved by treatments
at ambient and elevated temperatures

| | Ambient Temperature | 180° F. |
|---|---|---|
| Chlorate Composition | 83% | 73% |
| Persulfate | 48% | 74% |

The results show that at ambient temperature the chlorate composition was more effective than the persulfate in reducing viscosity.

### Example 3

### Efficacy of Chlorate Composition in Reducing Viscosity of a Polyacrylamide Composition Solvated in Brine

The efficacy of the chlorate composition in reducing viscosity of a polyacrylamide composition solvated in brine was tested.

### Methods

The methods were generally the same as in Examples 1 and 2, except that the polyacrylamide composition was solvated in a synthetic brine and the elevated temperature condition was 150° F. The brine was comprised of 1% sodium chloride in water by mass.

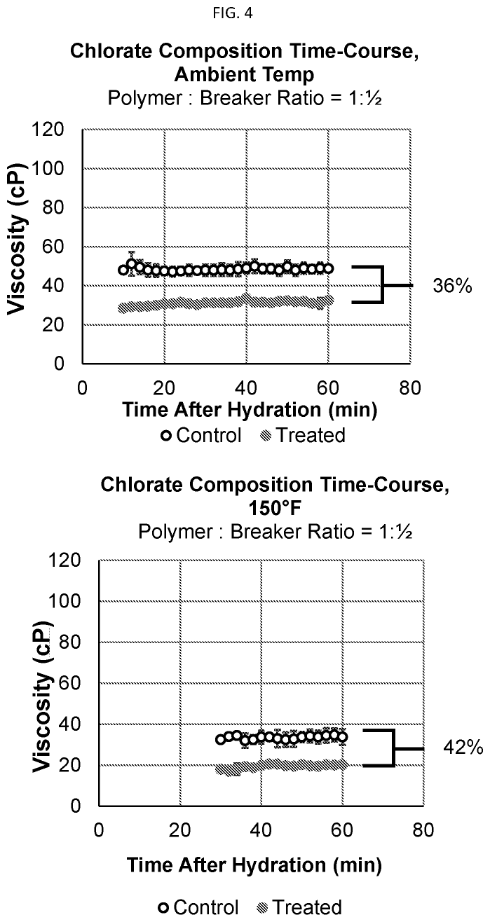

Results are shown in FIG. 4. The average viscosity reduction in the ambient temperature condition was 36%, and the average viscosity reduction in the elevated temperature condition was 42%. The results show that in both temperature conditions, the chlorate composition was effective in reducing the viscosity of the brine solvated polyacrylamide composition.

### Example 4

### Effect of Chlorate Composition on Viscosity of a Guar Composition

The effects of the chlorate composition on the viscosity of a guar composition was tested at ambient temperature and at an elevated temperature.

### Methods

The methods were similar to those described in Examples 1 and 3 except that guar rather than a polyacrylamide was employed. The guar composition was solvated using the following procedure. The guar composition (in this case, Ecopol-2000LMS, a commercially available polymer composition (from Economy Polymers & Chemicals) containing 30-60% guar gum) was drawn into a syringe and injected into 600 mL of deionized (DI) water in a jar. The solution was drawn back into the syringe and flushed back out into the jar four times. The solution was mixed vigorously by spinning at 1515 rpm using a drill press impeller for 10 min. The solution was then allowed to sit for 5 min. The solution was then mixed again by spinning at 1515 rpm for 5 min. The solution was then allowed to sit for 5 min. The solution was then mixed again by spinning at 1515 rpm for 5 min. The solvated guar composition was then immediately treated with the chlorate composition at ratio of 1:0.5 (v/v) as described in Example 1. The combined composition was stirred vigorously with a glass stir rod for 20 seconds. In the elevated temperature condition the solution was heated to 150° F.

An initial viscosity measurement was taken (at about 30 minutes after solvation in the ambient temperature condition and at 60 minutes after solvation in the elevated temperature condition (due to the time required for heating)) and every 2 minutes for 20 minutes (when 11 measurements had been taken). All viscosity measurements were taken using a Brookfield spindle viscometer at 60 RPM. Viscosity reduction was calculated as the percentage change between the viscosity in the control and the relevant experimental condition.

### Results

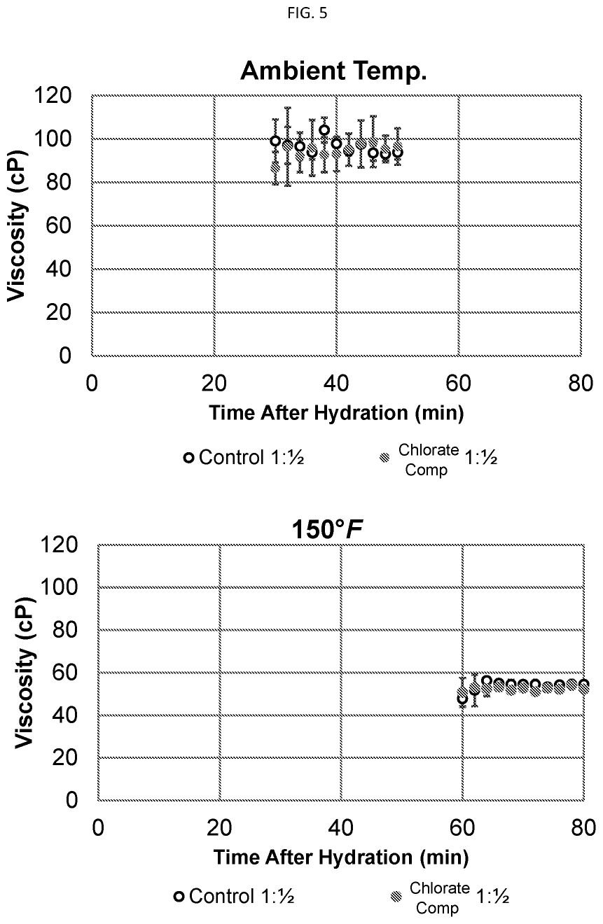

FIG. 5 shows the results of viscosity measurements taken at ambient temperature (top graph) and at 150° F. These results show that at both temperatures, the chlorate composition was ineffective in reducing the viscosity of the solvated guar composition.

### Example 5

### Viscosity Reducing Effect of Chlorate Compositions Compared with other Compositions

The viscosity reducing effects of several types of compositions on a polyacrylamide composition were tested at ambient temperature and at an elevated temperature.

### Methods

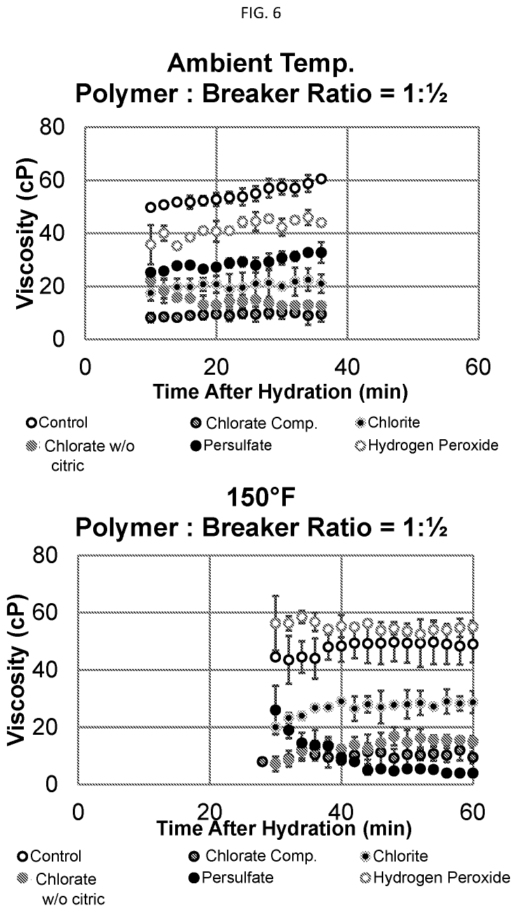

The methods were essentially the same as in Example 1, except that elevated temperature condition was included in which the combined breaker-polymer solution or control solution was heated to a temperature of 150° F. A polymer to breaker ratio of 1:0.5 was tested. The breakers tested included the chlorate composition as employed in Example 1 and a chlorate composition that was an aqueous solution of 31% sodium chlorate (referred to in FIG. 6 as “chlorate w/o citric”). Other breakers tested included persulfate (as described in Example 1), hydrogen peroxide, and chlorite. The hydrogen peroxide was an aqueous solution of 18% (w/w) hydrogen peroxide (Sigma-Aldrich, 50% w/w H202, stabilized stock, diluted to working concentration) The chlorite was an aqueous solution of 12.5% (w/w) sodium chlorite. Each of these was applied and the viscosity measured, as described in Example 1, at timepoints shown in FIG. 6.

### Results

Results are shown in FIG. 6. The chlorate compositions were effective in reducing viscosity of polyacrylamide compositions at ambient temperature and at elevated temperatures. At ambient temperature, the chlorate compositions were more effective than the alternative breakers tested, including hydrogen peroxide, chlorite, and persulfate. Furthermore, in the ambient temperature condition the viscosity reducing effects of the chlorate compositions persisted or improved over time, whereas the viscosity reducing effect of the hydrogen peroxide and persulfate diminished over time.

These results indicate that chlorate compositions have advantages over other breakers, including better viscosity reducing effects at lower (ambient) temperature as well as more persistent viscosity reducing effects. Accordingly, well treatments using a chlorate breaker to break polyacrylamide are advantageous for wells having lower temperatures. Well treatments using a chlorate breaker to break polyacrylamide are also advantageous for use in operations where a longer period of viscosity reduction is desired (e.g., to allow for fracking in stages and/or a shutting in period that may be for hours, days, or weeks).

### Example 6

### Chlorate Composition Produces Improved Viscosity Reduction Compared with Persulfate for a Further Polyacrylamide Composition

The experiments described in this Example investigated viscosity modifying effects of a chlorate composition and persulfate on a further polyacrylamide composition at ambient temperature.

### Methods

### Solvation of Polyacrylamide

The polyacrylamide composition was solvated using the following procedure. The polyacrylamide composition (a further friction reducer composition, different from that employed in previous examples, containing anionic polyacrylamide) was drawn into a syringe and injected into 600 mL of deionized (DI) water in a jar. The solution was drawn back into the syringe and flushed back out into the jar four times. The solution was mixed vigorously by spinning at 700 rpm using a drill press impeller for 1 minute. The solution was then allowed to sit for 9 minutes. The solution was then mixed again by spinning at 700 rpm for 1 minute. The solvated polyacrylamide composition was then immediately treated as described herein.

### Treatments

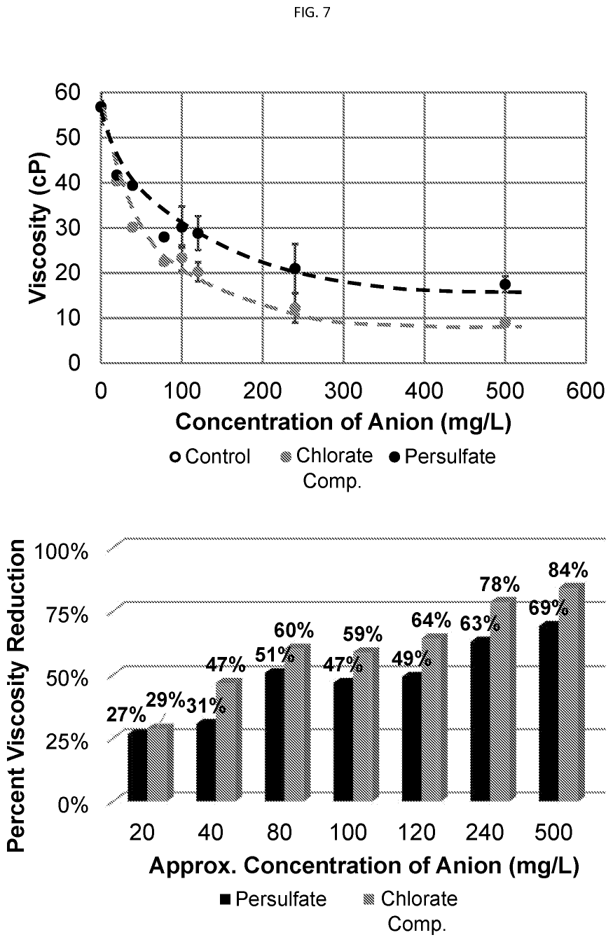

Persulfate was compared with a chlorate composition. The persulfate was a dry form of sodium persulfate (Fisher Scientific, Na₂S₂O₈>98%). The chlorate composition was an aqueous solution of 31% (w/w) sodium chlorate and 9% (w/w) citric acid. A breaker composition (the persulfate or chlorate composition) was added to the solvated polyacrylamide composition using a micropipette. The combined composition was stirred vigorously with a glass stir rod for 20 seconds. Several doses of breaker to solvated polymer composition were tested: 20 mg/L, 40 mg/L, 80 mg/L, 100 mg/L, 120 mg/L, 240 mg/L and 500 mg/L. As is indicated in FIG. 7, these doses refer to the concentration of anion (chlorate or persulfate anion) provided by the relevant breaker composition. A control composition was prepared in the same manner except that a comparable volume of water containing no breaker was added instead of breaker.

### Viscosity Measurements

An initial viscosity measurement was taken immediately (this timepoint was approximately 10 min after solvation and is labelled as 10 min. on the graphs showing the results) and every 2 minutes for 30 minutes (total of 11 viscosity measurements). All viscosity measurements were taken using a Brookfield spindle viscometer at 60 RPM. Viscosity reduction was calculated as the percentage change between the viscosity in the control and the relevant experimental condition.

### Results

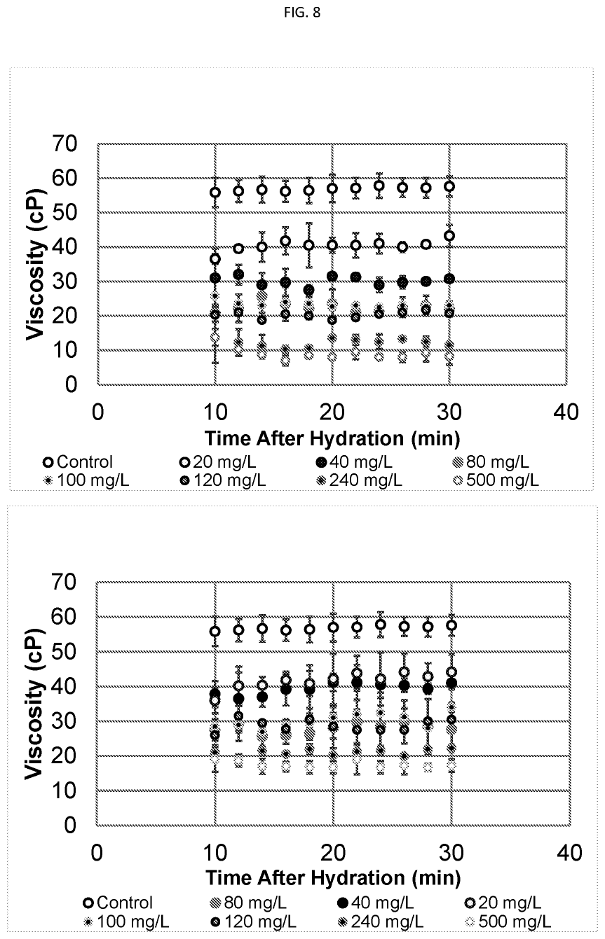

Results are presented in FIG. 7 and FIG. 8.

The top graph in FIG. 7 shows the dose response (average response across timepoints). The bottom graph in FIG. 7 shows the average viscosity reduction achieved by treatments with persulfate and with the chlorate composition. FIG. 8 shows the viscosity results as a function of time for the chlorate composition (top graph) and the persulfate (bottom graph).

These results show that at ambient temperature the chlorate composition reduced the viscosity of the polyacrylamide composition by about 30% to 85% (see FIG. 7, bottom graph). The results also show that the chlorate composition consistently outperformed the persulfate. At the doses of 40 mg/l to 500 mg/L, the chlorate composition provided substantially greater viscosity reduction.

### Example 7

### Viscosity Reducing and Molecular Weight Reducing Effects of Chlorate and Persulfate Compositions

In this Example, experiments were conducted to investigate viscosity reducing and size (molecular weight) reducing effects of chlorate and persulfate breaker compositions on polyacrylamide compositions at ambient temperature.

### Methods

Effects of breaker compositions (a chlorate composition and persulfate, both as described in Example 1) were tested on eight different polyacrylamide compositions.

The polyacrylamide compositions tested were eight friction reducers (FRs); six of them were anionic polyacrylamide compositions and the other two were cationic polyacrylamide compositions. The FRs were commercially available FRs suitable for use in hydraulic fracturing. See summary provided in Table 2.

Each of the polyacrylamide compositions was hydrated in a volume of 600 mL deionized (DI) water to make a hydrated composition having an initial target viscosity of approximately 50 cP. Different polyacrylamide compositions took different times to hydrate. Hydration information and actual initial average viscosities (from at least two replicate experiments) are provided in Table 3.

The chlorate composition was dosed at 1 gallon per thousand (GPT) and the persulfate was dosed at 3.2 lb/1000 gal into 600 mL volumes of each hydrated polyacrylamide composition. This dosing provided equivalent anion concentrations of chlorate and persulfate (about 316 mg/L of the respective anion).

### Viscosity Testing

Each of the breaker-treated hydrated compositions and corresponding untreated control compositions were subjected to viscosity testing at intervals over a period of 20 minutes. The viscosity testing was performed using a Brookfield viscometer (both analog and digital Brookfield viscometers were calibrated and used to ensure accuracy of viscometer readings). Multiple replicate experiments were performed for all conditions. Data shown in the figures are averages with error bars representing standard deviations (where are bars are not visible, they are too small to be seen).

TABLE 2
Polyacrylamide (PA) Compositions

| | #1 | #2 | #3 | #4 | #5 | #6 | #7 | #8 |
|---|---|---|---|---|---|---|---|---|
| Anionic or | Anionic | Anionic | Anionic | Anionic | Anionic | Anionic | Cat. | Cat. |
| Cationic (Cat.) | | | | | | | | |
| Emulsion (E) | E¹ | D | E¹ | D | D* | E¹* | D | E¹ |
| or Dry (D) | | | | | | | | |
| Other | | | | | | | | |
| components² | | | | | | | | |
| Distillates | 15-20% | N/A | 20-45% | 10-30% | N/A | 10-30% | N/A | 10-30% |
| (petroleum), | | | | | | | | |
| hydrotreated | | | | | | | | |
| light | | | | | | | | |
| Alcohols, | N/A | N/A | N/A | N/A | N/A | <5% | N/A | <5% |
| C12-C16, | | | | | | | | |
| ethoxylated | | | | | | | | |
| Alcohols, | N/A | N/A | N/A | N/A | N/A | <5% | N/A | <5% |
| C11-14-iso-, | | | | | | | | |
| C13-rich, | | | | | | | | |
| ethoxylated | | | | | | | | |
| Ammonium | <2% | N/A | N/A | N/A | N/A | N/A | N/A | <5% |
| chloride | | | | | | | | |
| Alcohols, C12- | N/A | N/A | N/A | <5% | N/A | N/A | N/A | N/A |
| 15-branched | | | | | | | | |
| and linear, | | | | | | | | |
| ethoxylated | | | | | | | | |
| propoxylated | | | | | | | | |
| Poly(oxy-1,2- | N/A | N/A | <5% | <3% | N/A | N/A | N/A | N/A |
| ethanediyl), α- | | | | | | | | |
| (4-nonylphenyl) | | | | | | | | |
| ω-hydroxy-, | | | | | | | | |
| branched | | | | | | | | |
| Oleic Acid | <2% | N/A | N/A | N/A | N/A | N/A | N/A | N/A |
| Diethanolamide | | | | | | | | |
| Adipic acid | N/A | N/A | N/A | N/A | N/A | N/A | ≤2.5% | N/A |
| Sulfamic acid | N/A | N/A | N/A | N/A | N/A | N/A | ≤2.5% | N/A |

¹Contained approximately 30% by weight polyacrylamide per telephone conversations with the manufacturers. The dry compositions may contain higher concentrations.
²Components disclosed by the manufacturers.
*designated by manufacturer as suitable for use with high total dissolved solids (TDS).

TABLE 3
Hydration Information for PA Compositions

| | #1 | #2 | #3 | #4 | #5 | #6 | #7 | #8 |
|---|---|---|---|---|---|---|---|---|
| Volume (ml) | 0.4 mL | 0.25 g | 0.5 mL | 3.5 mL | 0.4 g | 4.0 mL | 1.875 g | 7.0 mL |
| or Mass (g) | | | | | | | | |
| of PA | | | | | | | | |
| Composition | | | | | | | | |
| Fluid Sample | 0.6 | 0.6 | 0.6 | 0.6 | 0.6 | 0.6 | 2.5 | 0.6 |
| Volume (L) | | | | | | | | |
| Dose of | 200 | 420 | 250-300 | 1750 | 667 | 2.0-2.4 | 750 | 3,500-4,200 |
| Polyacrylamide | | | | | | | | |
| Composition in | | | | | | | | |
| Hydrated | | | | | | | | |
| Sample (mg/L) | | | | | | | | |
| Average | 50.3 | 52.0 | 58.7 | 48.6 | 63.0 | 55.3 | 36.8 | 75.5 |
| Viscosity (cP) | | | | | | | | |

### Molecular Weight Cut Off Testing

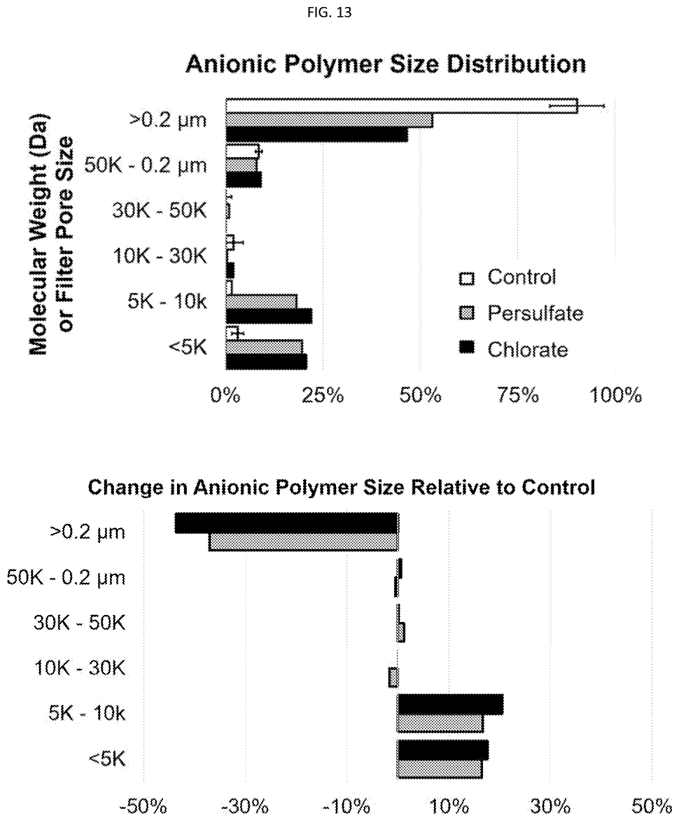

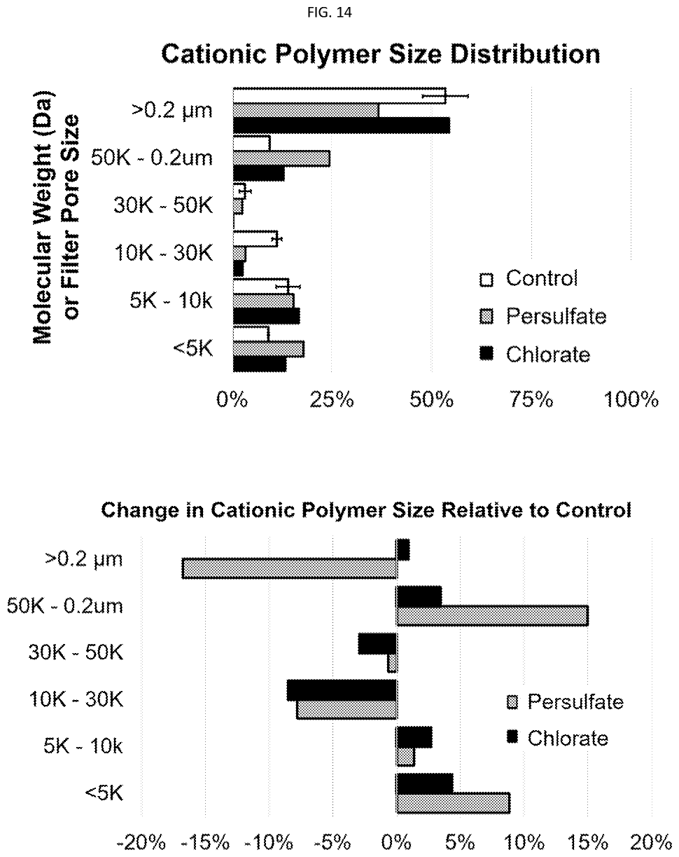

Molecular weight cut off (MWCO) testing was also performed with a subset of the polyacrylamide compositions (#3 and #8) to investigate effects on polymer size. For the MWCO testing, these polyacrylamide compositions were hydrated in 600 mL of DI water at doses of 1000 mg/L. Breaker treatment doses were adjusted to maintain anion equivalent doses of the respective breaker (chlorate or persulfate) to polyacrylamide. Chlorate composition-treated and persulfate composition-treated samples as well as untreated control samples of the hydrated polyacrylamide compositions were spiked onto filters (filters designed to filter out polymers of particular molecular weight or size, namely: molecular weight of less than 5KDa, 5KDa-10KDa, 30KDa-50KDa, 50KDa-100KDa, or size >0.2 μm) and the filters were centrifuged for 4 hours to allow for permeation by the samples. The permeated solution was then dehydrated in a 160° F. oven for at least 3 days. Dehydrated samples were weighed to determine the amount of polymer that permeated each filter size. These amounts were expressed as a percentage of the total to produce the polymer size distribution graphs shown in FIG. 13 and FIG. 14. The change in percentage at each polymer size relative to the control was also calculated to produce the graphs shown in the bottom of FIG. 13 and FIG. 14.

### Results

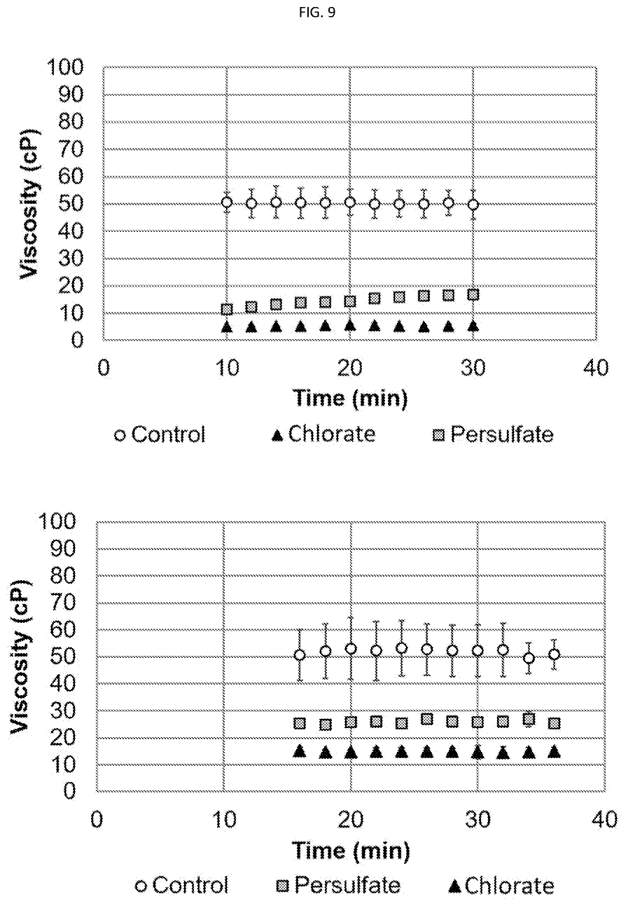

The viscosity over time for each of the conditions is shown in FIG. 9 to FIG. 12. Average viscosity reductions relative to control are shown in Table 4.

TABLE 4
Viscosity Reductions Provided by
Chlorate and Persulfate Treatments

| | Polyacrylamide (PA) Compositions | | | | | | | |
|---|---|---|---|---|---|---|---|---|
| | #1 | #2 | #3 | #4 | #5 | #6 | #7 | #8 |
| Chlorate | 89% | 71% | 89% | 33% | 68% | 16% | 45% | 0% |
| treatment | | | | | | | | |
| Persulfate | 71% | 50% | 84% | 4% | 63% | 11% | 78% | 19% |
| treatment | | | | | | | | |
| Difference | 18% | 21% | 5% | 29% | 5% | 5% | −33% | −19% |

FIG. 9 shows that for polyacrylamide compositions #1 (top graph) and #2 (bottom graph), chlorate provided consistently greater viscosity reduction than did persulfate. For PA compositions #1 and #2, respectively, chlorate provided viscosity reductions of 89% and 71%.

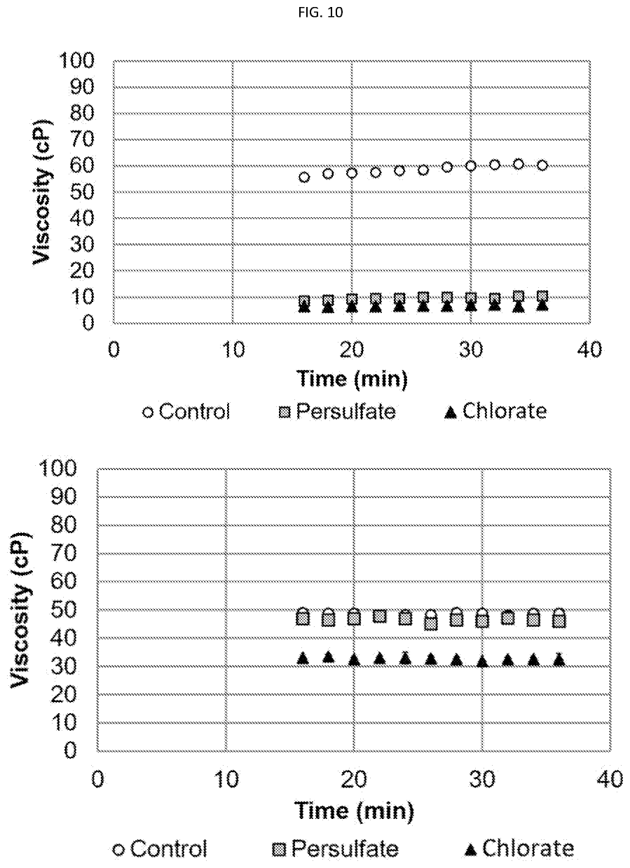

FIG. 10 shows that for the polyacrylamide composition #3 (top graph), chlorate and persulfate showed strong viscosity reducing effects. Relative to the control, both breaker compositions provided a substantial reduction in viscosity, with chlorate providing an average reduction of 89% and persulfate providing an average reduction of 84%

FIG. 10 shows that for PA composition #4 (bottom graph), chlorate performed consistently better than persulfate. The average viscosity reduction provided by chlorate was more than 8 fold the viscosity reduction provided by persulfate (see Table 4).

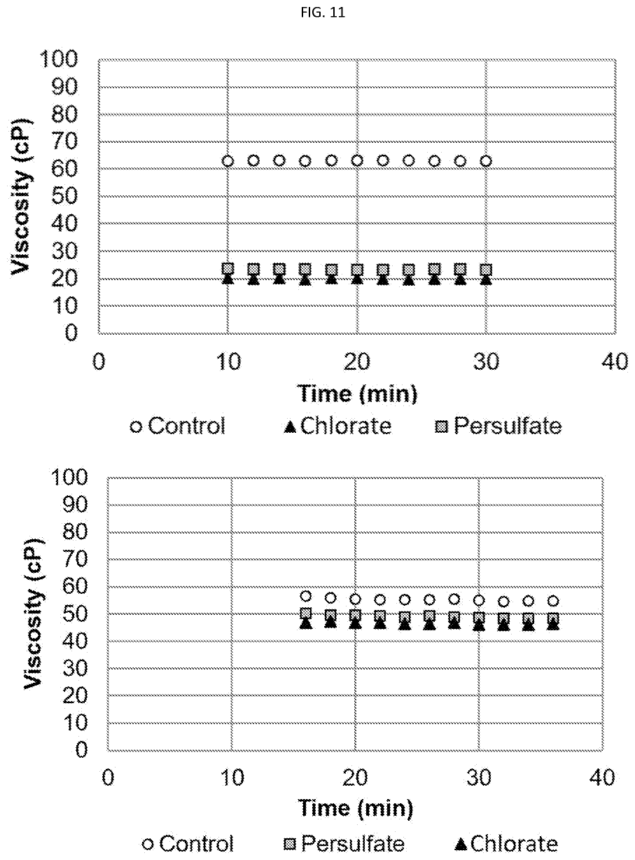

FIG. 11 shows results for additional PA compositions that are suitable for use in high TDS fluids. For PA composition #5 (FIG. 11, top graph) and #6 (FIG. 11, bottom graph), chlorate showed a consistently greater viscosity reducing effect compared with persulfate.

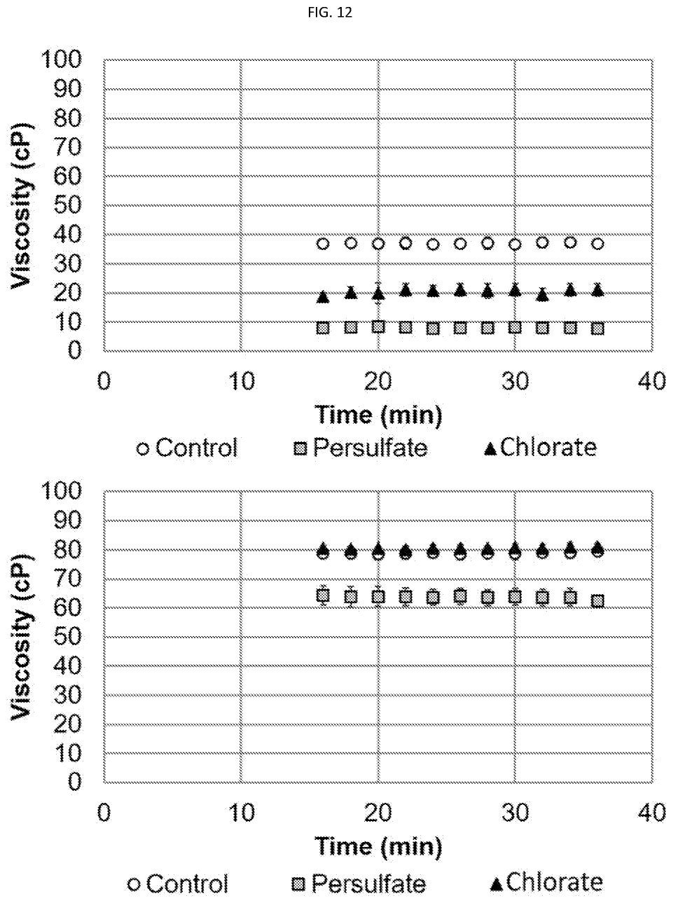

FIG. 12 shows results for cationic PA compositions # 7 (top graph) and #8 (bottom graph). Chlorate showed a viscosity reducing effect for PA composition #7 but appeared to have no such effect on composition #8.

MWCO results are shown in FIGS. 13 and 14. FIG. 13 shows the results for anionic PA composition #3. These results indicate that chlorate had a substantial effect in breaking polymers of the largest sizes (>0.2 μm), producing the observed decrease in the percentage of polymer of that size and increase in the percentage of smaller polymers (<5 KDa and 5-10 KDa). The MWCO results for composition #3 are consistent with the viscosity reduction results shown in the top graph in FIG. 10. FIG. 14 shows the MWCO results for composition #8. These results are also consistent with the viscosity reduction results for PA composition #8; however, although chlorate had no effect on the largest size polymers, chlorate produced some reduction in polymers of 10 KDa-50 KDa, increasing polymers of 5 KDa-10 KDa and <5 KDa.

Overall, the results of this Example indicate that chlorate outperforms persulfate in breaking anionic polacrylamide, as indicated by its consistently greater viscosity reducing effects. Also, while persulfate failed to produce viscosity reduction for anionic polyacrylamide composition #4, chlorate had a clear viscosity reducing effect.

These results of this Example support the use of chlorate as an alternative polyacrylamide breaker, particularly for anionic polyacrylamide. Furthermore, the results confirm that chlorate produces viscosity reducing and size reducing effects at ambient temperature.

The entire content of any references cited herein is incorporated by reference.

1. A well treatment fluid comprising at least 40 ppm anionic polyacrylamide, and a chlorate salt in an amount that provides a relative concentration of 3% to 40% (w/w) chlorate anion to anionic polyacrylamide, the well treatment fluid having a pH of 5 to 8.

2. The well treatment fluid of claim 1, wherein the well treatment fluid has a pH of 6 to 8.

3. The well treatment fluid of claim 1 or 2, wherein the well treatment fluid contains at least 90% anionic polyacrylamide relative to other polymers, if any.

4. The well treatment fluid of any one of claims 1 to 3, wherein the well treatment fluid contains at least 90% by weight chlorate anions relative to total weight of other breaker anions included in the well treatment fluid, if any.

5. The well treatment fluid of any one of claims 1 to 4, wherein the chlorate salt reduces the viscosity of the well treatment fluid by at least 15% compared with an otherwise corresponding composition that does not comprise the chlorate salt.

6. The well treatment fluid of any one of claims 1 to 4, wherein the chlorate salt reduces the viscosity of the well treatment fluid by at least 40% compared with an otherwise corresponding composition that does not comprise the chlorate salt.

7. The well treatment fluid of any one of claims 1 to 4, wherein the chlorate salt reduces the viscosity of the well treatment fluid by at least 60% compared with an otherwise corresponding composition that does not comprise the chlorate salt.

8. A method comprising introducing the well treatment fluid of any one of claims 1 to 7 into a hydrocarbon bearing subterranean formation.

9. A method comprising mixing well treatment components to form a well treatment fluid, the well treatment components including (a) an aqueous base fluid, (b) anionic polyacrylamide, and (c) a chlorate composition that provides a relative concentration of 3% to 40% (w/w) chlorate anion to anionic polyacrylamide in the well treatment fluid, wherein the well treatment fluid initially comprises at least 40 ppm anionic polyacrylamide and has a pH of 5 to 8.

10. The method of claim 9, the well treatment components further comprising a proppant.

11. The method of claim 9 or 10, wherein the well treatment fluid contains a proportion of at least 90% (w/w) anionic polyacrylamide relative to other polymers, if any.

12. The method of any one of claims 9 to 11, wherein the well treatment fluid contains at least 90% by weight chlorate anions relative to total weight of other breaker anions included in the well treatment fluid, if any.

13. A well treatment fluid according to the method of any one of claims 9 to 12.

14. A method comprising mixing well treatment components to form a well treatment fluid, the well treatment components including (a) an aqueous base fluid, (b) a friction reducer comprising 20% to 35% anionic polyacrylamide, and (c) a chlorate composition that provides a relative concentration of 3% to 40% (w/w) chlorate anion to the anionic polyacrylamide in the well treatment fluid, wherein the well treatment fluid initially comprises at least 40 ppm anionic polyacrylamide and has a pH of 5 to 8.

15. The method of claim 14, wherein the friction reducer is in the form of an emulsion comprising 20% to 35% anionic polyacrylamide.

16. The method of claim 14 or 15, the well treatment components further including a proppant.

17. The method of any one of claims 14 to 16, wherein the well treatment fluid contains a proportion of at least 90% (w/w) anionic polyacrylamide relative to other polymers, if any.

18. The method of any one of claims 14 to 17, wherein the well treatment fluid contains at least 90% by weight chlorate anions relative to total weight of other breaker anions included in the well treatment fluid, if any.

19. A well treatment fluid made according to the method of any one of claims 14 to 18.

20. The method of any one of claims 9 to 12 and 14 to 18, further comprising introducing the well treatment fluid into a wellbore, or portion thereof, penetrating a hydrocarbon bearing subterranean formation.

21. The method of claim 20, further comprising retrieving fluid comprising broken anionic polyacrylamide from the hydrocarbon bearing subterranean formation.

22. The method of claim 20 or 21, wherein the introducing is within 15 minutes of the mixing.

23. The method of any one of claims 20 to 22, wherein the introducing comprises pumping the well treatment fluid into the wellbore at a flow rate and pressure sufficient to fracture the formation.

24. A method of decreasing viscosity of a well treatment fluid, the method comprising introducing a chlorate composition and a well treatment fluid comprising anionic polyacrylamide into a hydrocarbon bearing subterranean formation such that anionic polyacrylamide from the well treatment fluid is exposed to chlorate from the chlorate composition.

25. The method of claim 24, comprising introducing the chlorate composition in proportion to the well treatment fluid so as to provide a chlorate concentration, in fluid formed by combination of the well treatment fluid and the chlorate composition, which is sufficient to provide a decreased viscosity in said fluid, wherein said decreased viscosity is at least 15% less than the initial viscosity of the well treatment fluid.

26. The method of claim 24, comprising introducing the chlorate composition in proportion to the well treatment fluid so as to provide a chlorate concentration, in fluid formed by combination of the well treatment fluid and the chlorate composition, which is sufficient to provide a decreased viscosity in said fluid, wherein said decreased viscosity is at least 40% less than the initial viscosity of the well treatment fluid.

27. The method of claim 24, comprising introducing the chlorate composition in proportion to the well treatment fluid so as to provide a chlorate concentration, in fluid formed by combination of the well treatment fluid and the chlorate composition, which is sufficient to provide a decreased viscosity in said fluid, wherein said decreased viscosity is at least 60% less than the initial viscosity of the well treatment fluid.

28. The method of any one of claims 24 to 27, wherein the chlorate composition is introduced in proportion to the well treatment fluid so as to provide a relative concentration of at least 3% (w/w) chlorate anion to polyacrylamide in fluid formed by combination of the well treatment fluid and the chlorate composition.

29. The method of any one of claims 24 to 28, wherein the method comprises mixing the well treatment fluid with the chlorate composition to form a mixture and introducing the mixture into the hydrocarbon bearing subterranean formation.

30. The method of any one of claims 24 to 29, wherein the method comprises pumping the chlorate composition and the well treatment fluid into a wellbore or portion thereof that penetrates the hydrocarbon bearing subterranean formation.

31. The method of claim 30, wherein the wellbore or portion thereof has a temperature of less than 110° F.

32. The method of claim 30 or 31, further comprising retrieving flowback fluid from the wellbore, the flowback fluid comprising broken polyacrylamide.

33. The method of claim 32, wherein the retrieving is more than 2 days after the introducing.

34. The method of any one of claims 24 to 33, wherein the chlorate composition comprises solid sodium chlorate.

35. The method of any one claims 24 to 33, wherein the chlorate composition comprises an aqueous solution of sodium chlorate.

36. The method of any one of claims 24 to 35, wherein the chlorate composition, the well treatment fluid, or both comprise one or more other breakers and the chlorate composition comprises a proportion of at least 90% chlorate anion by weight relative to the total weight of anions from the other breakers.

37. The method of any one of claims 24 to 36, wherein the chlorate composition is encapsulated.

38. The method of any one of claims 24 to 37, wherein the well treatment fluid contains a proportion of at least 90% by weight of anionic polyacrylamide relative to other polymers, if any.

39. The method of claim 38, wherein the well treatment fluid contains less than 10% guar or guar derivatives relative to other polymers.

40. The method of claim 39, wherein the well treatment fluid contains less than 5% guar or guar derivatives relative to other polymers.
